(19) United States
(12) Patent Application Publication
(10) Pub. No.: US 2025/0053194 A1
(43) Pub. Date: Feb. 13, 2025

(54) FOLDABLE DEVICE INCLUDING DIGITIZER

(71) Applicant: Samsung Electronics Co., Ltd., Suwon-si (KR)

(72) Inventors: Myeongsil PARK, Suwon-si (KR); Byungduk YANG, Suwon-si (KR)

(21) Appl. No.: 18/899,473

(22) Filed: Sep. 27, 2024

Related U.S. Application Data
(63) Continuation of application No. PCT/KR2024/011419, filed on Aug. 2, 2024.

(30) Foreign Application Priority Data
Aug. 8, 2023 (KR) 10-2023-0103730
Sep. 5, 2023 (KR) 10-2023-0117745

(51) Int. Cl. G06F 1/16; G06F 3/047

(52) U.S. Cl. CPC G06F 1/1618; G06F 1/1643; G06F 1/1652; G06F 3/047

(57) ABSTRACT

An electronic device is provided. The electronic device includes a first housing, a second housing rotatably connected to the first housing, a display panel disposed across the first housing and the second housing, and a digitizer plate disposed below the display panel and including wires of a digitizer, wherein the digitizer plate includes a first plate area disposed in the first housing, a second plate area disposed in the second housing, and a pattern area provided between the first plate area and the second plate area and including a plurality of openings, wherein the first plate area and the second plate area of the digitizer plate includes a plurality of layers including a first layer and a second layer where the wires of the digitizer are provided, and at least one additional layer, and wherein the at least one additional layer in the first plate area and/or the second plate area is provided with an additional wire electrically connected to the wires of the digitizer provided on the first layer and/or the second layer.

### CROSS-REFERENCE TO RELATED APPLICATION(S)

This application is a continuation application, claiming priority under § 365(c), of an International application No. PCT/KR2024/011419, filed on Aug. 2, 2024, which is based on and claims the benefit of a Korean patent application number 10-2023-0103730, filed on Aug. 8, 2023, in the Korean Intellectual Property Office, and of a Korean patent application number 10-2023-0117745, filed on Sep. 5, 2023, in the Korean Intellectual Property Office, the disclosure of each of which is incorporated by reference herein in its entirety.

### TECHNICAL FIELD

The disclosure relates to an electronic device. More particularly, the disclosure relates a foldable electronic device including a foldable display.

### BACKGROUND ART

Portable electronic devices (hereinafter, referred to as electronic devices), such as smart phones, are able to provide users with a variety of user experiences using various applications. When providing applications or multimedia content on electronic devices, there is a demand from users for a larger screen. However, since portability is also an important factor, there are limitations to expanding the size of a display. Accordingly, recently, electronic devices with various form factors in which the display area of a display is variable are being developed. A foldable device may have a form factor that is capable of being fully folded and unfolded by including a flexible display.

The electronic device may include a digitizer to detect a touch input using the user's finger or the stylus. The digitizer may include a plurality of wires to detect and transmit a signal corresponding to the touch input.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

In a foldable device, which has a structure that is foldable with reference to the center, it is not easy to design the wires of a digitizer. For example, when design is made such that the wires of the digitizer are not disposed at the connection portion of the two housings that are folded together, the two housings may each need a connector connected to the digitizer driving IC and/or may need to be connected via a separate FPCB. Accordingly, there is a problem in that the thickness of the electronic device increases and the structure becomes more complex.

Aspects of the disclosure are to address at least the above-mentioned problems and/or disadvantages and to provide at least the advantages described below. Accordingly, an aspect of the disclosure is to provide a foldable electronic device including a foldable display.

### Solution to Problem

In accordance with an aspect of the disclosure, an electronic device is provided. The electronic device includes a first housing, a second housing rotatably connected to the first housing, a display panel disposed across the first housing and the second housing, and a digitizer plate disposed below the display panel and including wires of a digitizer, wherein the digitizer plate includes a first plate area disposed in the first housing, a second plate area disposed in the second housing, and a pattern area provided between the first plate area and the second plate area and including a plurality of openings, wherein the first plate area and the second plate area of the digitizer plate include a plurality of layers including a first layer and a second layer where the wires of the digitizer are provided, and at least one additional layer, and wherein the at least one additional layer in the first plate area and/or the second plate area is provided with an additional wire electrically connected to the wires of the digitizer provided on the first layer and/or the second layer.

In accordance with another aspect of the disclosure, an electronic device is provided. The electronic device includes a first housing, a second housing, and a hinge housing connected to the first housing and the second housing, and a flexible display disposed on a foldable housing and including a display panel and a support plate disposed between the display panel and the foldable housing, wherein the support plate includes a first area corresponding to the first housing, a second area corresponding to the second housing, and a folding area corresponding to the hinge housing, and further includes patterns to bend the folding area, wherein the support plate includes wires to detect an electronic pen, and wherein, among the wires, at least two wires disposed on different layers of the folding area of the support plate extend in parallel in a first direction via the folding area.

### Advantageous Effects of Invention

According to various embodiments of the disclosure, in the foldable device, the wires of the digitizer are configured to avoid the openings provided in the connection portion of the two housings. Thus, the thickness of the foldable device can be reduced. In addition, the resistance of the wires of the digitizer can be reduced by using an additional wire connected to the wires of the digitizer. Thus, touch detection performance can be improved.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A, 2B, 2C, and 2D illustrate an electronic device that can be folded left and right according to various embodiments of the disclosure;

FIG. 2E illustrates an electronic device having a plurality of folding areas according to an embodiment of the disclosure;

FIGS. 3A, 3B, 3C, 3D, and 3E illustrate an electronic device that can be folded up and down according to various embodiments of the disclosure;

FIG. 4 illustrates a laminated structure of a display according to an embodiment of the disclosure;

FIG. 5 illustrates a laminated structure of a digitizer according to an embodiment of the disclosure;

FIG. 6 illustrates a laminated structure of a display according to an embodiment of the disclosure;

FIGS. 7A and 7B illustrate a connector connected to a digitizer driving IC according to an embodiment of the disclosure;

FIG. 8 illustrates wires passing through a pattern area according to an embodiment of the disclosure;

FIG. 9 illustrates a laminated structure of a digitizer plate according to an embodiment of the disclosure.

FIGS. 10A, 10B, and 10C illustrate examples of Y-channel wires provided on a digitizer plate according to various embodiments of the disclosure;

FIG. 11 illustrates wires provided on a second layer and an additional layer of a top edge area of an electronic device in a pattern area according to an embodiment of the disclosure;

FIG. 12 illustrates an example of X-channel wires provided on a digitizer plate according to an embodiment of the disclosure;

FIGS. 13A, 13B, 13C, and 13D illustrate examples of wires provided on a plurality of layers of a digitizer plate according to various embodiments of the disclosure;

FIGS. 14A, 14B, 14C, 14D, 14E, and 14F illustrate the arrangement structures of additional wires according to various embodiments of the disclosure;

FIGS. 15A and 15B illustrate arranged positions of additional wires according to various embodiments of the disclosure;

FIGS. 16A, 16B, 16C, and 16D illustrate an electronic device having a slidable structure that is horizontally expandable according to various embodiments of the disclosure; and

FIGS. 17A and 17B illustrate an electronic device with a slidable structure that is vertically expandable according to various embodiments of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

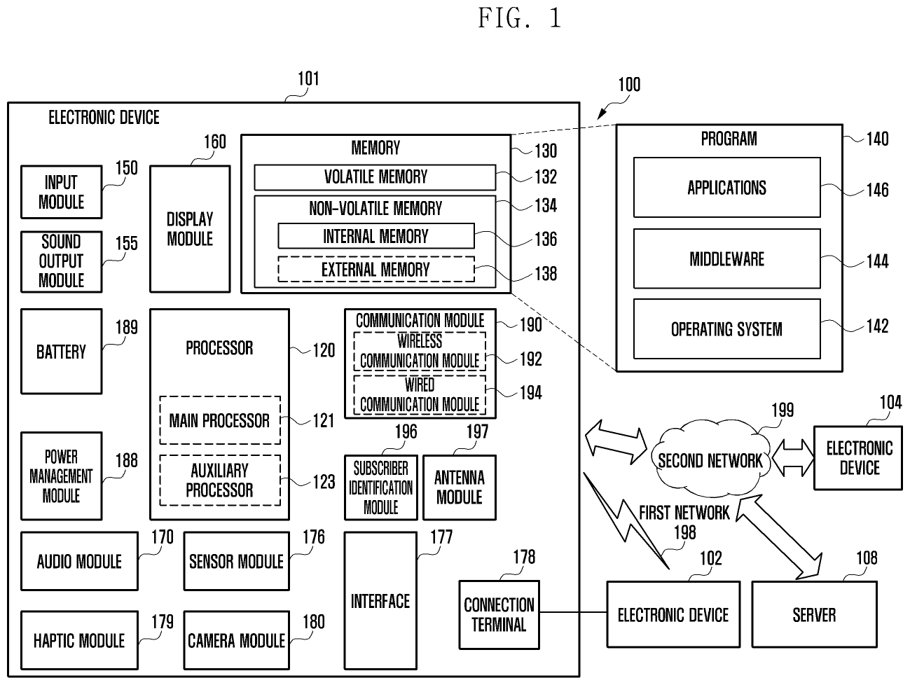

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

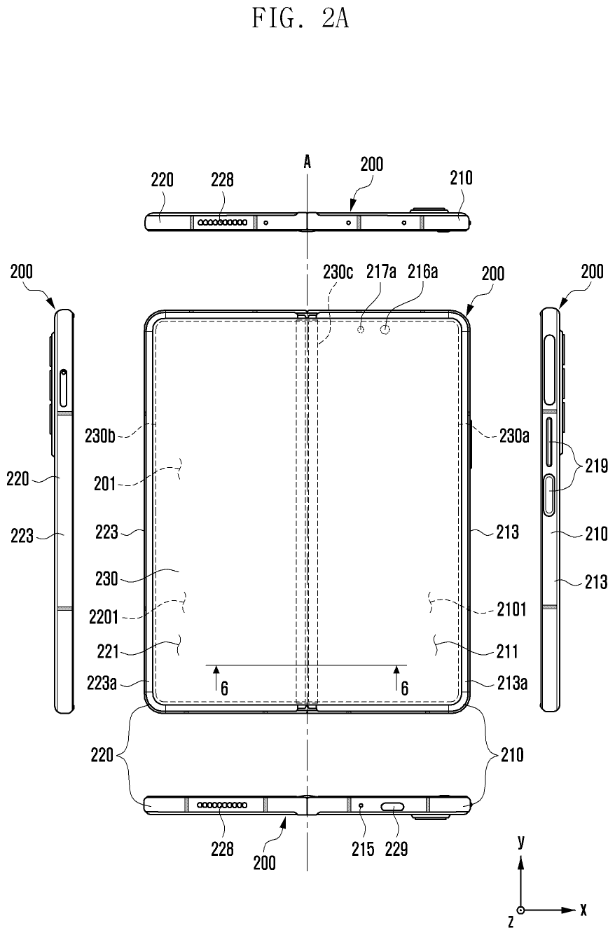

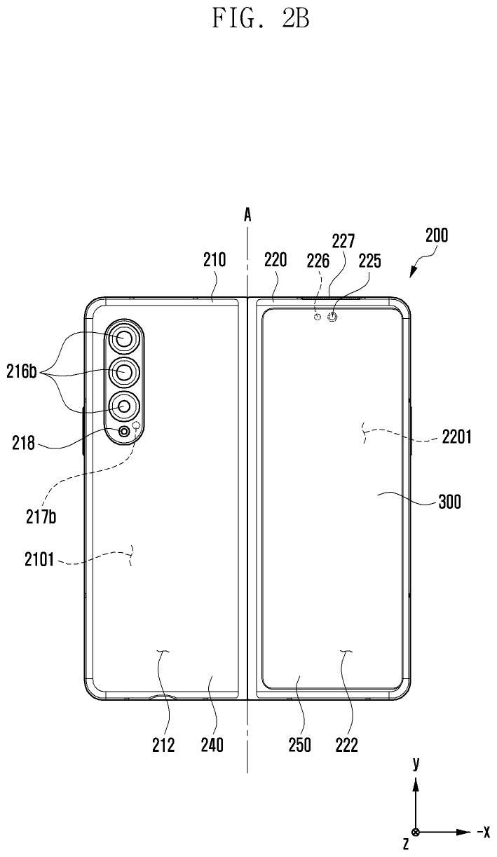

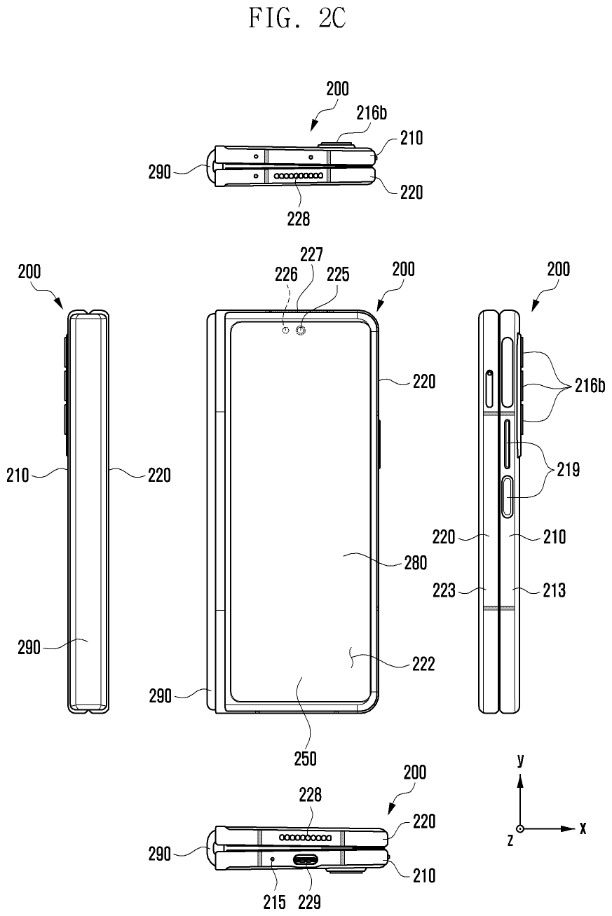

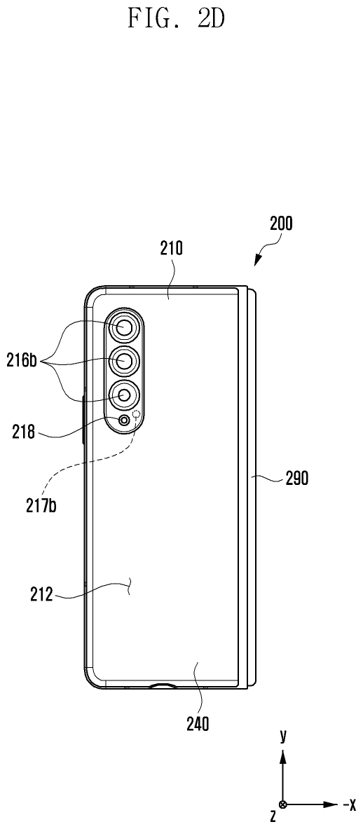

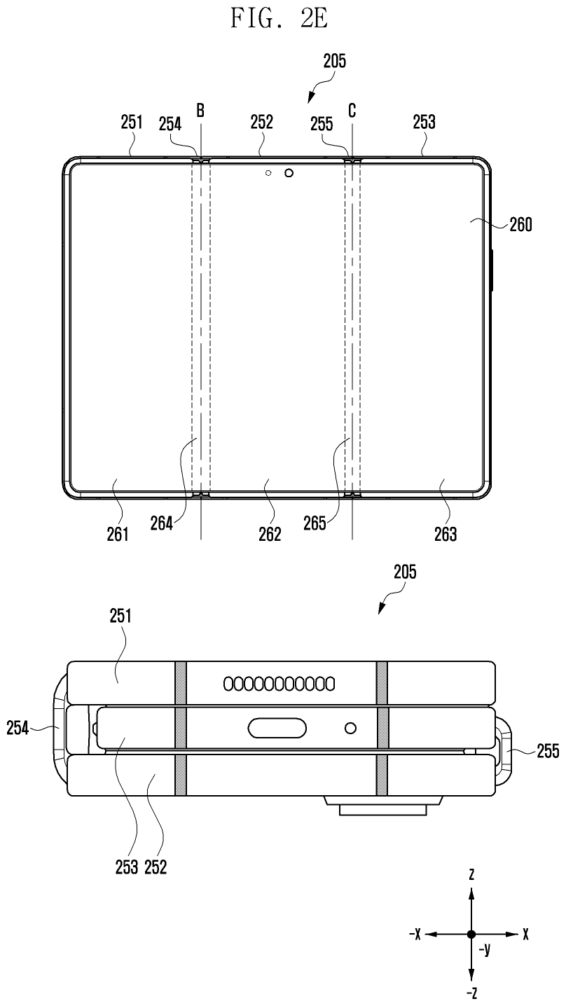

FIGS. 2A, 2B, 2C, and 2D illustrate an electronic device that can be folded left and right according to various embodiments of the disclosure.

FIGS. 2A and 2B are front and rear views of the electronic device in the unfolded state, and FIGS. 2C and 2D are front and rear views of the electronic device in the folded state. According to an embodiment of the disclosure, the electronic device 200 may include a foldable structure that is folded left and right about a vertical folding axis A.

Referring to FIGS. 2A to 2D, an electronic device 200 may include a pair of housings 210 and 220 (or a foldable housing structure) coupled to each other via a hinge device to be rotatable about a folding axis A to be foldable with respect to each other, and a first display (or a flexible display, a foldable display, or a main display) disposed on the pair of housings 210 and 220 and/or a second display 280 (or a sub-display) disposed on a second housing 220. According to an embodiment of the disclosure, at least a portion of the hinge device may be disposed to be invisible from the outside through the first housing 210 and the second housing 220, and in the unfolded state, the hinge housing 290, which covers the foldable portion, may be disposed to be invisible from the outside.

According to an embodiment of the disclosure, the hinge device may include a gear assembly including a plurality of gears, a hinge module including a plurality of hinge cams coupled to hinge shafts rotating via the gear assembly and configured to perform a cam interlocking operation, and hinge plates interconnecting the hinge module and the first and second housings 210 and 220. Herein, the surface on which the first display 230 is disposed may be defined as the front surface of the electronic device 200, and the surface opposite to the front surface may be defined as the rear surface of the electronic device 200. In addition, the surface surrounding the space between the front surface and the rear surface may be defined as the side surface of the electronic device 200.

According to an embodiment of the disclosure, the pair of housings 210 and 220 may include a first housing 210 and a second housing 220 that are foldable relative to each other via the hinge device. According to an embodiment of the disclosure, the pair of housings 210 and 220 are not limited to the shape and assembly illustrated in FIGS. 2A to 2D, but may be implemented by other shapes or other combinations and/or assemblies of components. According to an embodiment of the disclosure, the first housing 210 and the second housing 220 may be disposed on opposite sides of the folding axis A and may have shapes that are generally symmetrical to each other with respect to the folding axis A. According to some embodiments of the disclosure, the first housing 210 and the second housing 220 may be folded asymmetrically with respect to the folding axis A. According to an embodiment of the disclosure, the first housing 210 and the second housing 220 may form an angle or have a distance therebetween, which may be variable depending on whether the electronic device 200 is in the unfolded state, in the folded state, or in the intermediate state.

According to an embodiment of the disclosure, in the unfolded state of the electronic device 200, the first housing 210 may include a first surface 211 connected to the hinge device and disposed to face the front side of the electronic device 200, a second surface 212 facing away from the first surface 211, and/or a first side surface member 213 surrounding at least a portion of a first space 2101 between the first surface 211 and the second surface 212. According to an embodiment of the disclosure, in the unfolded state of the electronic device 200, the second housing 220 may include a third surface 221 connected to the hinge device and disposed to face the front side of the electronic device 200, a fourth surface 222 facing away from the third surface 221, and/or a second side surface member 223 surrounding at least a portion of a second space 2201 between the third surface 221 and the fourth surface 222. According to an embodiment of the disclosure, the first surface 211 may be oriented in substantially the same direction as the third surface 221 in the unfolded state and may at least partially face the third surface 221 in the folded state. According to an embodiment of the disclosure, the electronic device 200 may include a recess 201 provided to accommodate the first display 230 through structural coupling between the first housing 210 and the second housing 220. According to an embodiment of the disclosure, the recess 201 may have substantially the same size as the first display 230. According to an embodiment of the disclosure, the first housing 210 may include a first protection frame 213a which is coupled to the first side surface member 213 and disposed to overlap the periphery of the first display 230 when the first display 230 is viewed from above, thereby covering the periphery of the first display 230 to be invisible from the outside. According to an embodiment of the disclosure, the first protection frame 213a may be integrated with the first side surface member 213. According to an embodiment of the disclosure, the second housing 220 may include a second protection frame 223a (or a second decoration member) which is coupled to the second side surface member 223 and disposed to overlap the periphery of the first display 230 when the first display 230 is viewed from above, thereby covering the periphery of the first display 230 to be invisible from the outside. According to an embodiment of the disclosure, the second protection frame 223a may be integrated with the second side surface member 223. In some embodiments of the disclosure, the first protection frame 213a and the second protection frame 223a may be omitted.

According to an embodiment of the disclosure, the hinge housing 290 (or hinge cover) may be disposed between the first housing 210 and the second housing 220 to cover a portion of the hinge device disposed in the hinge housing 290. According to an embodiment of the disclosure, the hinge housing 290 may be covered by a portion of the first housing 210 and the second housing 220 or exposed to the outside, depending on whether the electronic device 200 is in the unfolded state, the folded state, or the intermediate state. For example, when the electronic device 200 is in the unfolded state, at least a portion of the hinge housing 290 may be disposed to be covered by the first housing 210 and the second housing 220 not to be exposed. According to an embodiment of the disclosure, when the electronic device 200 is in the folded state, at least a portion of the hinge housing 290 may be disposed between the first housing 210 and the second housing 220 to be exposed to the outside. According to an embodiment of the disclosure, when the electronic device is in the intermediate state in which the first housing 210 and the second housing 220 are folded with a certain angle, the hinge housing 290 may be disposed between the first housing 210 and the second housing 220 to be at least partially exposed to the outside of the electronic device 200. For example, the area of the hinge housing 290 exposed to the outside may be smaller than that in the case where the electronic device is fully folded. According to an embodiment of the disclosure, the hinge housing 290 may include a curved surface.

According to an embodiment of the disclosure, when the electronic device 200 is in the unfolded state (e.g., the state in FIGS. 2A and 2B), the first housing 210 and the second housing 220 form an angle of about 180 degrees therebetween, and the first area 230a, the second area 230b, and the folding area 230c of the first display 230 may be arranged to be oriented in substantially the same direction (e.g., the z-axis direction) while substantially forming the same plane. As another embodiment of the disclosure, when the electronic device 200 is in the unfolded state, the first housing 210 may rotate by an angle of about 360 degrees with respect to the second housing 220 to be folded in the opposite direction such that the second surface 212 and the fourth surface 222 face each other (out-folding type).

According to an embodiment of the disclosure, when the electronic device 200 is in the folded state (e.g., the state in FIGS. 2C and 2D), the first surface 211 of the first housing 210 and the third surface 221 of the second housing 220 may be disposed to face each other. In this case, the first area 230a and the second area 230b of the first display 230 may form a narrow angle (e.g., in the range of 0 degrees to about 10 degrees) with respect to each other via the folding area 230c, and may be disposed to face each other. According to an embodiment of the disclosure, at least a portion of the folding area 230c may be transformed into a curved shape with a predetermined curvature. According to an embodiment of the disclosure, when the electronic device 200 is in the intermediate state, the first housing 210 and the second housing 220 may be disposed to form a certain angle therebetween. In this case, the first area 230a and the second area 230b of the first display 230 may form an angle that is greater than that in the folded state and smaller than that in the unfolded state, and the curvature of the folding area 230c may be smaller than that in the folded state and greater than that in the unfolded state. In some embodiments of the disclosure, the first housing 210 and the second housing 220 may form an angle that can stop at a predetermined folding angle between the folded state and the unfolded state via the hinge device (free stop function). In some embodiments of the disclosure, the first housing 210 and the second housing 220 may be continuously operated while being pressed in the unfolding or folding direction with reference to a predetermined inflection angle via the hinge device.

According to an embodiment of the disclosure, the electronic device 200 may include at least one of the following components: one or more displays 230 and 280, input devices 215, sound output devices 227 and 228, sensor modules 217a, 217b, and 226, camera modules 216a, 216b, and 225, key input devices 219, indicators (not illustrated), or connector ports 229 which are disposed on or in the first housing 210 and/or the second housing 220. In some embodiments of the disclosure, at least one of the components may be omitted from the electronic device 200, or at least one other component may be additionally included in the electronic device 200.

According to an embodiment of the disclosure, the one or more displays 230 and 280 may include a first display 230 disposed to be supported by the first surface 211 of the first housing 210 and the third surface 221 of the second housing 220 via the hinge device, and a second display 280 disposed in the inner space of the second housing 220 to be at least partially visible from the outside through the fourth surface 222. In some embodiments of the disclosure, the second display 280 may be disposed in the inner space of the first housing 210 to be visible from the outside through the second surface 212. According to an embodiment of the disclosure, the first display 230 may be mainly used when the electronic device 200 is in the unfolded state, and the second display 280 may be mainly used when the electronic device 200 is in the folded state. According to an embodiment of the disclosure, when the electronic device 200 is in the intermediate state, the electronic device 200 may be controlled such that the first display 230 and/or the second display 280 can be used based on the folding angle between the first housing 210 and the second housing 220.

According to an embodiment of the disclosure, the first display 230 may be placed in an accommodation space defined by the pair of housings 210 and 220. For example, the first display 230 may be disposed in the recess 201 defined by the pair of housings 210 and 220, and may be disposed to occupy substantially most of the front surface of the electronic device 200 in the unfolded state. According to an embodiment of the disclosure, the first display 230 may include a flexible display in which at least a partial area may be transformed into a flat shape or a curved shape. According to an embodiment of the disclosure, the first display 230 may include a first area 230a facing the first housing 210 and a second area 230b facing the second housing 220. According to an embodiment of the disclosure, the first display 230 may include a folding area 230c including a portion of the first area 230a and a portion of the second area 230b with reference to the folding axis A. According to an embodiment of the disclosure, at least a portion of the folding area 230c may include an area corresponding to the hinge device. According to an embodiment of the disclosure, the area division of the first display 230 is merely an exemplary physical division based on the pair of housings 210 and 220 and the hinge device, and in practice, the first display 230 may display a single seamless entire screen via the pair of housings 210 and 220 and the hinge device. According to an embodiment of the disclosure, the first area 230a and the second area 230b may have an overall symmetrical shape or a partially asymmetrical shape with respect to the folding area 230c.

According to an embodiment of the disclosure, the electronic device 200 may include a first rear surface cover 240 disposed on the second surface 212 of the first housing 210 and a second rear surface cover 250 disposed on the fourth surface 222 of the second housing 220. In some embodiments of the disclosure, at least a portion of the first rear surface cover 240 may be integrated with the first side surface member 213. In some embodiments of the disclosure, at least a portion of the second rear surface cover 250 may be integrated with the second side surface member 223. According to an embodiment of the disclosure, at least one of the first rear surface cover 240 and the second rear surface cover 250 may be made of a substantially transparent plate (e.g., a glass plate including various coating layers, or a polymer plate) or an opaque plate. According to an embodiment of the disclosure, the first rear surface cover 240 may be made of, for example, coated or colored glass, ceramic, polymer, metal (e.g., aluminum, stainless steel (STS), or magnesium), or an opaque plate, such as a combination of two or more of these materials. According to an embodiment of the disclosure, the second rear surface cover 250 may be made of a substantially transparent plate of, for example, glass or polymer. Accordingly, the second display 280 may be disposed in the inner space of the second housing 220 to be visible from the outside through the second rear surface cover 250.

According to an embodiment of the disclosure, the input devices 215 may include a microphone. In some embodiments of the disclosure, the input devices 215 may include a plurality of microphones disposed to detect the direction of sound. According to an embodiment of the disclosure, the sound output devices 227 and 228 may include speakers. According to an embodiment of the disclosure, the input devices 215, the sound output devices 227 and 228, and the connector ports 229 may be disposed in the spaces of the first housing 210 and/or the second housing 220, and may be exposed to the external environment through one or more holes provided in the first housing 210 and/or the second housing 220. According to an embodiment of the disclosure, the sound output devices 227 and 228 may include a speaker that operates without holes in the first housing 210 and/or the second housing 220 (e.g., a piezo speaker).

According to an embodiment of the disclosure, the camera modules 216a, 216b, and 225 may include a first camera module 216a disposed on the first surface 211 of the first housing 210, a second camera module 216b disposed on the second surface 212 of the first housing 210, and/or a third camera module 225 disposed on the fourth surface 222 of the second housing 220. In an embodiment of the disclosure, the electronic device 200 may include a flash 218 located near the second camera module 216b.

According to an embodiment of the disclosure, the sensor modules 217a, 217b, and 226 may generate electrical signals or data values corresponding to an internal operating state or an external environmental state of the electronic device 200. According to an embodiment of the disclosure, the sensor modules 217a, 217b, and 226 may include a first sensor module 217a disposed on the first surface 211 of the first housing 210, a second sensor module 217b disposed on the second surface 212 of the first housing 210, and/or a third sensor module 226 disposed on the fourth surface 222 of the second housing 220. According to an embodiment of the disclosure, the sensor modules 217a, 217b, and 226 may include at least one of a gesture sensor, a grip sensor, a color sensor, an infrared (IR) sensor, an illumination sensor, an ultrasonic sensor, an iris recognition sensor, or a distance detection sensor (e.g., a time-of-flight (TOF) sensor or a light detection and ranging (LiDAR) sensor).

According to an embodiment of the disclosure, the key input devices 219 may be disposed to be exposed outside through the first side surface member 213 of the first housing 210. For example, the key input device 219 may be disposed to be exposed outside through the second side surface member 223 of the second housing 220.

According to an embodiment of the disclosure, the connector ports 229 may include a connector (e.g., a USB connector or an interface connector port module (IF module)) configured to transmit/receive power and/or data to and from an external electronic device.

According to an embodiment of the disclosure, one or more camera modules 216a and 225 among the camera modules 216a, 216b, and 225, one or more sensor modules 217a and 226 among the sensor modules 217a, 217b, and 226, and/or an indicator may be disposed to be exposed through one or more displays 230 and 280. For example, the at least one camera modules 216a or 225, the at least one sensor module 217a or 226, and/or the indicator may be disposed in the inner space of the at least one housing below the active area (display area) of the at least one display, and may be disposed to come into contact with the external environment through an opening perforated up to the cover member (e.g., a window layer (not illustrated) of the first display 230 and/or the second rear surface cover 250) or a transparent area. According to an embodiment of the disclosure, an area in which the at least one display 230 or 280 and the at least one camera module 216a or 225 face each other may be provided as a transmission area with a predetermined transmittance as a portion of a content display area. According to an embodiment of the disclosure, the transmission area may have a transmittance ranging from about 5% to about 20%. The transmission area may include an area overlapping the effective area (e.g., a view angle area) of the at least one camera module 216a or 225 through which light captured by an image sensor to generate an image passes. For example, the transmission areas of the displays 230 and 280 may include an area having a lower pixel density than the periphery. For example, the transmission area may replace the opening. For example, the at least one camera module 216a or 225 may include an under-display camera (UDC) or an under-panel camera (UPC). As another embodiment of the disclosure, some camera modules or sensor modules 217a and 226 may be arranged to perform the functions thereof without being visually exposed through a display. For example, the areas facing the camera modules 216a and 225 and/or the sensor modules 217a and 226 disposed under the displays 230 and 280 (e.g., a display panel) have an under-display camera (UDC) structure, and may not require a perforated opening. According to an embodiment of the disclosure, the pixel density of the area including the UDC may be the same as the pixel density of the surrounding area, and in this case, the driving circuit to drive the pixels in the UDC area may be placed in the surrounding area rather than the UDC area. This may increase the transmittance of light input to the camera in the UDC area.

FIG. 2E illustrates an electronic device having a plurality of folding areas according to an embodiment of the disclosure.

Hereinafter, descriptions of configurations corresponding to those described with reference to FIGS. 2A to 2D will be omitted.

Referring to FIG. 2E, the electronic device may include a flexible display 260, and the flexible display 260 may be disposed across the first housing 251, the second housing 252, and the third housing 253, which are sequentially arranged in that order.

According to an embodiment of the disclosure, the first housing 251 and the second housing 252 may be folded or unfolded with respect to each other via a first hinge member 254. For example, the first housing 251 and the second housing 252 may be coupled to be rotatable about a folding axis B by using the first hinge member 254. The second housing 252 and the third housing 253 may be folded or unfolded with respect to each other via a second hinge member 255. For example, the second housing 252 and the third housing 253 may be coupled to be rotatable about a folding axis C by using the first hinge member 255.

According to an embodiment of the disclosure, a first folding area 264 may be provided between the first housing 251 and the second housing 252. The first folding area 264 may be configured in a lattice structure including a plurality of openings. The first folding area 264 may provide an elastic force by expanding or reducing the size of the openings when the first housing 251 and the second housing 252 are folded or unfolded.

According to an embodiment of the disclosure, a second folding area 265 may be provided between the second housing 252 and the third housing 253. The second folding area 265 may be configured in a lattice structure including a plurality of openings. The second folding area 265 may provide an elastic force by expanding or reducing the size of the openings when the second housing 252 and the third housing 253 are folded or unfolded.

According to an embodiment of the disclosure, the electronic device 205 may be completely folded in the following order: the third housing 253 is folded first with respect to the second housing 252 through the second hinge member 255 between the second housing 252 and the third housing 253, and the first housing 251 is folded with respect to the second housing 252 and the third housing 253 folded via the first hinge member 254 between the first housing 251 and the second housing 252. To this end, the area of the first folding area 264 may be wider than the area of the second folding area 265. For example, firstly, the third display area 263 and the second display area 262 of the flexible display 260 are folded to face each other via the second hinge member 255, and secondarily, the first display area 261 of the flexible display 260 and the rear of the third housing 253 are folded to face each other.

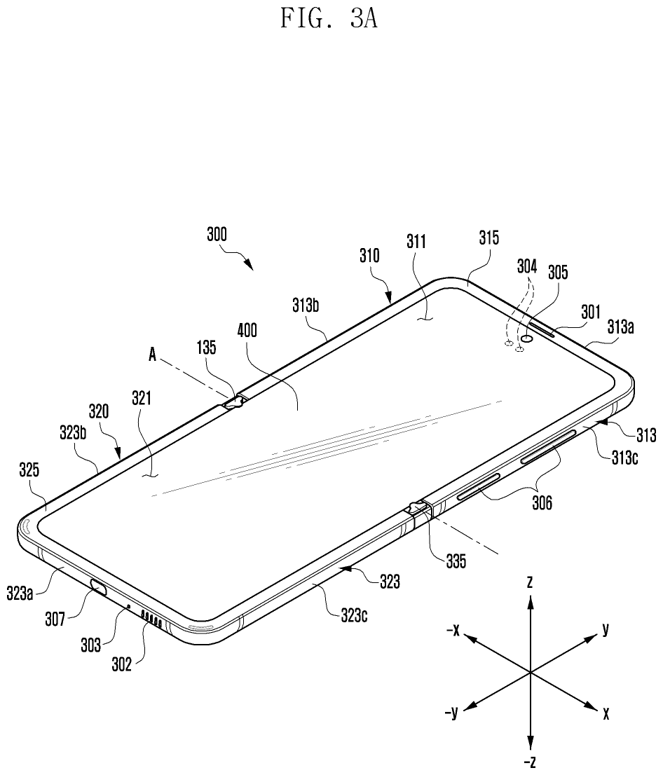

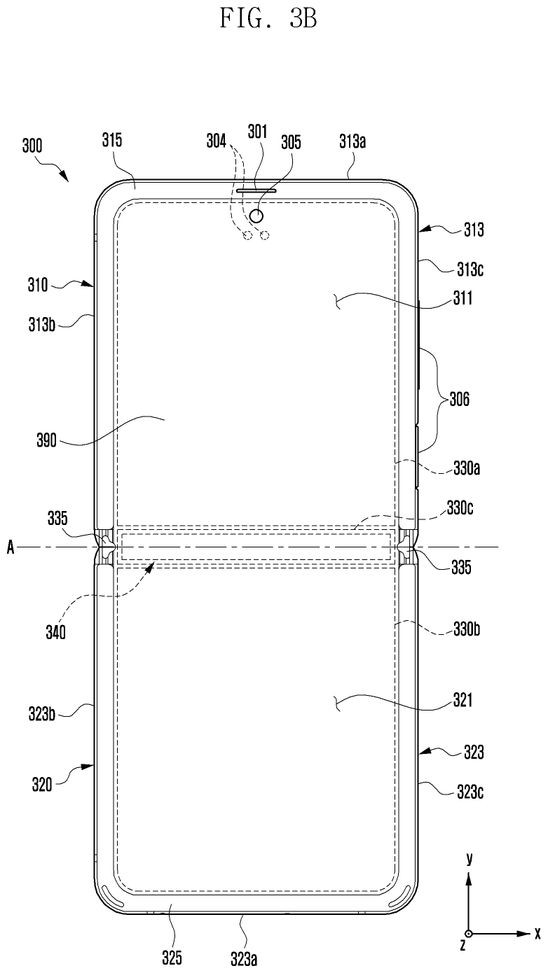

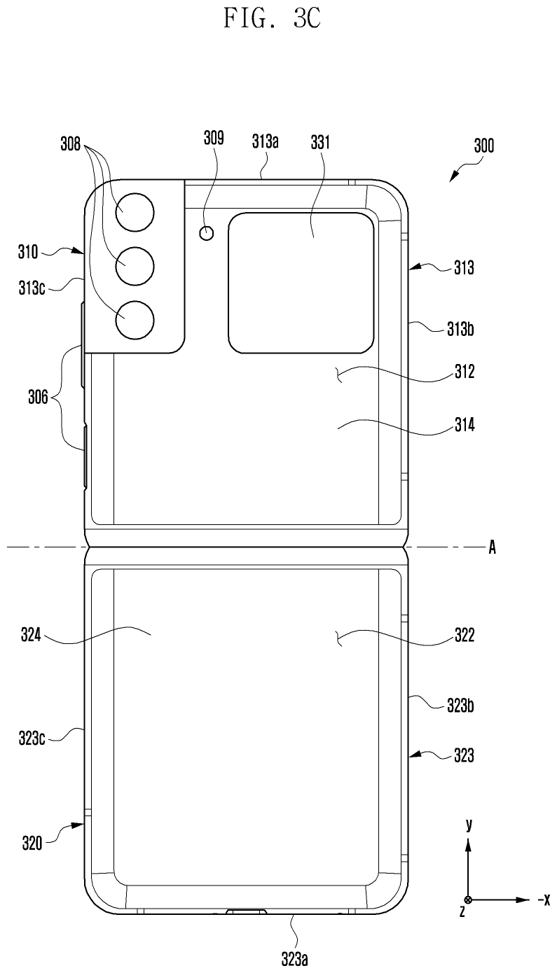

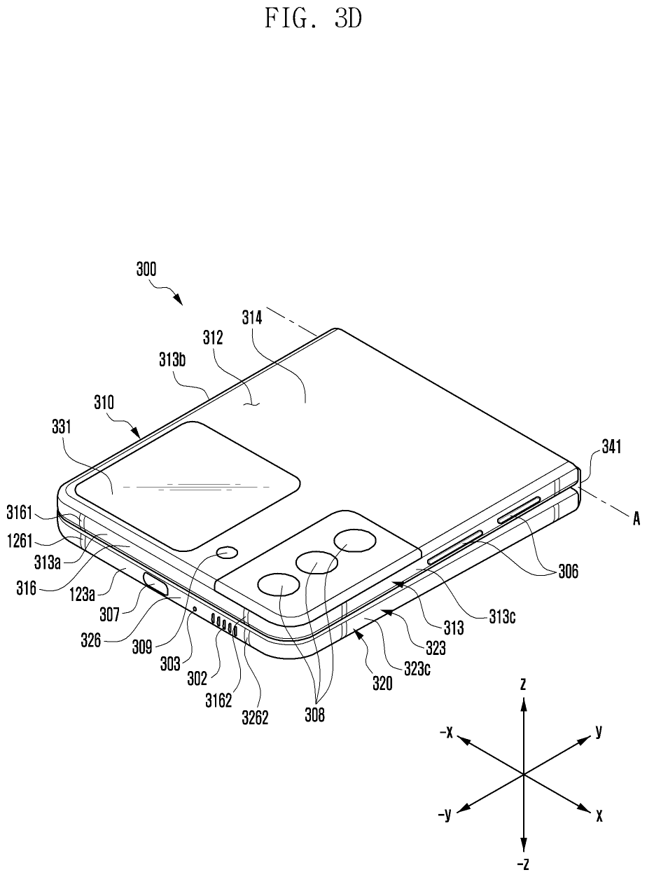

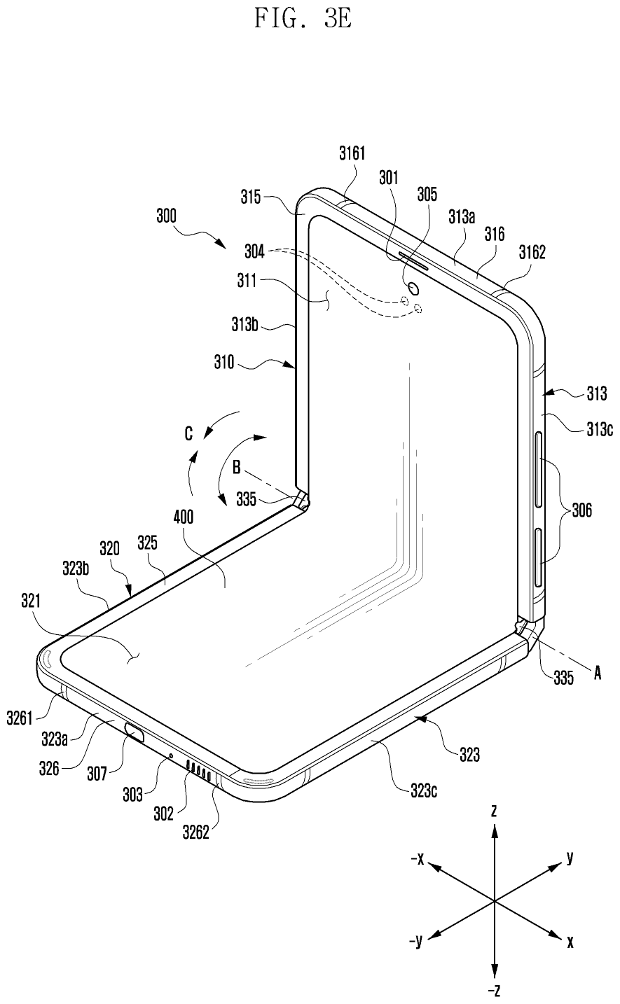

FIGS. 3A, 3B, 3C, 3D, and 3E illustrate an electronic device that can be folded up and down according to various embodiments of the disclosure.

FIG. 3A is a perspective view of the electronic device in an unfolded state (or flat state), FIG. 3B is a front view illustrating the electronic device in the unfolded state, and FIG. 3C is a rear view illustrating the electronic device in the unfolded state. FIG. 3D is a perspective view illustrating the electronic device in the folded state, and FIG. 3E is a perspective view illustrating the electronic device in the intermediate state. According to an embodiment of the disclosure, the electronic device 300 may include a foldable structure that is folded up and down about a horizontal folding axis A.

Referring to FIGS. 3A to 3E, the electronic device 300 may include a pair of housings 310 and 320 (e.g., a foldable housing), which are rotatably coupled to each other to be folded about a hinge device so as to face each other. According to an embodiment of the disclosure, the hinge device may be arranged in the x-axis direction or the y-axis direction, and two or more hinge devices may be arranged to be folded in the same direction or in different directions. According to an embodiment of the disclosure, the electronic device 300 may include a flexible display 390 (or a foldable display) disposed in an area defined by a pair of housings 310 and 320.

According to an embodiment of the disclosure, the first housing 310 and the second housing 320 may be disposed on opposite sides about a folding axis (axis A), and may have substantially symmetrical shapes with respect to the folding axis (axis A). According to an embodiment of the disclosure, the first housing 310 and the second housing 320 may form an angle or a distance therebetween, which may be variable depending on whether the electronic device 300 is in the unfolded or flat state, in the folded state, or in the intermediate state.

According to an embodiment of the disclosure, the pair of housings 310 and 320 may include a first housing 310 (or a first housing structure) coupled to the hinge device and a second housing 320 (or a second housing structure) coupled to the hinge device. According to an embodiment of the disclosure, in the unfolded state, the first housing 310 may include a first surface 311 oriented in a first direction (e.g., to face the front side) (the z-axis direction) and a second surface 312 oriented in a second direction (e.g., to face the rear side) (the −z-axis direction) opposite to the first surface 311. According to an embodiment of the disclosure, the second housing 320 may include, in the unfolded state, a third surface 321 oriented in the first direction (the z-axis direction) and a fourth surface 322 oriented in the second direction (the −z-axis direction). According to an embodiment of the disclosure, the electronic device 300 may be operated such that, in the unfolded state, the first surface 311 of the first housing 310 and the third surface 321 of the second housing 320 are oriented in substantially the same direction, i.e., the first direction (the z-axis direction) and in the folded state, the first surface 311 and the third surface 321 face each other. According to an embodiment of the disclosure, the electronic device 300 may be operated such that, in the unfolded state, the second surface 312 of the first housing 310 and the fourth surface 322 of the second housing 320 are oriented in substantially the same direction, i.e., the second direction (the −z-axis direction) and in the folded state, the second surface 312 and the fourth surface 322 are oriented in opposite directions. For example, in the folded state, the second surface 312 may be oriented in the first direction (the z-axis direction), and the fourth surface 322 may be oriented in the second direction (−z-axis direction).

According to an embodiment of the disclosure, the first housing 310 may include a first side surface member 313 defining at least a portion of the exterior of the electronic device 300, and a first rear surface cover 314 coupled to the first side surface member 313 and defining at least a portion of the second surface 312 of the electronic device 300. According to an embodiment of the disclosure, the first side surface member 313 may include a first side surface 313a, a second side surface 313b extending from one end of the first side surface 313a, and a third side surface 313c extending from the other end of the first side surface 313a. According to an embodiment of the disclosure, the first side surface member 313 may have a rectangular (e.g., square or oblong) shape configured by the first side surface 313a, the second side surface 313b, and the third side surface 313c.

According to an embodiment of the disclosure, the second housing 320 may include a second side surface member 323 defining at least a portion of the exterior of the electronic device 300, and a second rear surface cover 324 coupled to the second side surface member 323 and defining at least a portion of the fourth surface 322 of the electronic device 300. According to an embodiment of the disclosure, the second side surface member 323 may include a fourth side surface 323a, a fifth side surface 323b extending from one end of the fourth side surface 323a, and a sixth side surface 323c extending from the other end of the fourth side surface 323a. According to an embodiment of the disclosure, the second side surface member 323 may be provided in a rectangular shape through the fourth side surface 323a, the fifth side surface 323b, and the sixth side surface 323c.

According to an embodiment of the disclosure, the pair of housings 310 and 320 are not limited to the illustrated shape and assembly, but may be implemented by other shapes or other combinations and/or assemblies of components. For example, the first side surface member 313 and the first rear surface cover 314 may be integrally configured, and the second side surface member 323 and the second rear surface cover 324 may be integrally configured.

According to an embodiment of the disclosure, when the electronic device 300 is in the unfolded state, the second side surface 313b of the first side surface member 313 and the fifth side surface 323b of the second side surface member 323 may be connected to each other without a gap. According to an embodiment of the disclosure, when the electronic device 300 is in the unfolded state, the third side surface 313c of the first side surface member 313 and the sixth side surface 323c of the second side surface member 323 may be connected to each other without a gap. According to an embodiment of the disclosure, the electronic device 300 may be configured such that, in the unfolded state, the total length of the second side surface 313b and the fifth side surface 323b is longer than the length of the first side surface 313a and/or the fourth side surface 323a. In addition, the total length of the third side surface 313c and the sixth side surface 323c may be longer than the length of the first side surface 313a and/or the fourth side surface 323a. According to an embodiment of the disclosure, the electronic device 300 may be configured such that, in the unfolded state, the total length of the second side surface 313b and the fifth side surface 323b is shorter than or equal to the length of the first side surface 313a and/or the fourth side surface 323a. In addition, the electronic device may be configured such that the total length of the third side surface 313c and the sixth side surface 323c may be shorter than and equal to the length of the first side surface 313a and/or the fourth side surface 323a.

According to an embodiment of the disclosure, the first side surface member 313 and/or the second side surface member 323 may be made of a metal or may further include a polymer injection-molded onto the metal. According to an embodiment of the disclosure, the first side surface member 313 and/or the second side surface member 323 may include at least one conductive portion 316 and/or 126 electrically split from each other through at least one split portion 3161, 3162, 3262 and/or 1261, 1262 made of polymer. In this case, the at least one conductive portion may be used as an antenna operating in at least one predetermined band (e.g., a legacy band) by being electrically connected to a wireless communication circuit included in the electronic device 300.

According to an embodiment of the disclosure, the first rear surface cover 314 and the second rear surface cover 324 may be made of at least one of, for example, coated or colored glass, ceramic, polymer, or metal (e.g., aluminum, stainless steel (STS), or magnesium) or a combination of at least two of these materials.

According to an embodiment of the disclosure, the flexible display 390 may be disposed to extend from the first surface 311 of the first housing 310 to at least a portion of the third surface 321 of the second housing 320 across the hinge device. For example, the flexible display 390 may include a first area 330a substantially corresponding to the first surface 311, a second area 330b corresponding to the third surface 321, and a third area 330c (or a bendable area) interconnecting the first area 330a and the second area 330b and corresponding to the hinge device. According to an embodiment of the disclosure, the electronic device 300 may include a first protection cover 315 (or a first protection frame or a first decoration member) coupled along the periphery of the first housing 310. According to an embodiment of the disclosure, the electronic device 300 may include a second protection cover 325 (or a second protection frame or a second decoration member) coupled along the periphery of the second housing 320. According to an embodiment of the disclosure, the first protection cover 315 and/or the second protection cover 325 may be made of a metal or polymer material. According to an embodiment of the disclosure, the first protection cover 315 and/or the second protection cover 325 may be used as a decoration member. According to an embodiment of the disclosure, the flexible display 390 may be located such that the periphery of the first flat area 330a is interposed between the first housing 310 and the first protection cover 315.

According to an embodiment of the disclosure, the flexible display 390 may be located such that the periphery of the second area 330b is interposed between the second housing 320 and the second protection cover 325. According to an embodiment of the disclosure, the flexible display 390 may be located such that the periphery of the flexible display 390 corresponding to the protective cap 335 can be protected by a protection cap disposed in an area corresponding to the hinge device. Accordingly, the periphery of the flexible display 390 can be substantially protected from the outside. According to an embodiment of the disclosure, the electronic device 300 may include a hinge housing 341 (e.g., a hinge cover) configured to support the hinge device, in which the hinge housing is arranged to be exposed to the outside when the electronic device 300 is in the folded state and to be invisible from the outside by being moved into a first space (e.g., the inner space of the first housing 310) and a second space (e.g., the inner space of the second housing 320) when the electronic device 300 is in the unfolded state. According to an embodiment of the disclosure, the flexible display 390 may be disposed to extend from at least a portion of the second surface 312 to at least a portion of the fourth surface 322. In this case, the electronic device 300 may be folded to expose the flexible display 390 to the outside (an out-folding type).

According to an embodiment of the disclosure, the electronic device 300 may include a sub-display 331 disposed separately from the flexible display 390. According to an embodiment of the disclosure, the sub-display 331 may be disposed on the second surface 312 of the first housing 310 to be at least partially exposed so as to display status information of the electronic device 300 in place of the display function of the flexible display 390 when the electronic device 300 is in the folded state. According to an embodiment of the disclosure, the sub-display 331 may be disposed to be visible from the outside through at least a partial area in the first rear surface cover 314. According to an embodiment of the disclosure, the sub-display 331 may be disposed on the fourth surface 322 of the second housing 320. In this case, the sub-display 331 may be disposed to be visible from the outside through at least a partial area of the second rear surface cover 324.

According to an embodiment of the disclosure, the electronic device 300 may include at least one of an input device (e.g., a microphone 303), sound output devices (e.g., a call receiver 301 and a speaker 302), a sensor module 304, a camera device (e.g., a first camera device 305 or a second camera device 308), a key input device 306, or a connector port 307. In the illustrated embodiment of the disclosure, the input device (e.g., a microphone 303), the sound output device (e.g., a call receiver 301 and a speaker 302), the sensor module 304, the camera devices (e.g., a first camera device 305 and a second camera device 308), the key input devices 306, or the connector port 307 are indicated as holes or shapes provided in the first housing 310 or the second housing 320, but may be defined as including practical electronic components (e.g., an input device, a sound output device, a sensor module, or a camera device) disposed inside the electronic device 300 and operating through the holes or shapes.

According to an embodiment of the disclosure, the input device may include at least one microphone 303 disposed in the second housing 320. According to an embodiment of the disclosure, the sound output device may include call receivers 301 and speakers 302. According to an embodiment of the disclosure, the sound output device may include a call receiver 301 disposed in the first housing 310 and a speaker 302 disposed in the second housing 320. According to an embodiment of the disclosure, the input device (e.g., a microphone 303), the sound output device (e.g., a call receiver 301 and a speaker 302), and the connector port 307 may be disposed in a space provided in the first housing 310 and/or a space provided in the second housing 320 of the electronic device 300, and may be exposed to the external environment through at least one hole provided in the first housing 310 and/or the second housing 320. According to an embodiment of the disclosure, at least one connector port 307 may be used to transmit/receive power and/or data to/from an external electronic device.

According to an embodiment of the disclosure, the sensor module 304 may generate electrical signals or data values corresponding to an internal operating state or an external environmental state of the electronic device 300. The sensor module 304 may detect an external environment through, for example, the first surface 311 of the first housing 310.

According to an embodiment of the disclosure, the camera devices include a first camera device 305 (e.g., a front camera device) disposed on the first surface 311 of the first housing 310 and a second camera device 308 disposed on the second surface 312 of the first housing 310. The electronic device 300 may further include a flash 309 disposed near the second camera device 308.

According to an embodiment of the disclosure, the key input devices (e.g., key buttons 306) may be arranged on the third side surface 313c of the first side surface member 313 of the first housing 310. According to an embodiment of the disclosure, the key input devices (e.g., key buttons 306) may be disposed on at least one of the other side surfaces 313a and 113b of the first housing 310 and/or the side surfaces 323a, 123b, and 123c of the second housing 320.

Referring to FIG. 3E, the electronic device 300 may be operated to maintain the intermediate state via the hinge device. In this case, the electronic device 300 may control the flexible display 390 such that the display area corresponding to the first surface 311 and the display area corresponding to the third surface 321 display different contents, respectively. According to an embodiment of the disclosure, with reference to a predetermined inflection angle (e.g., the angle between the first housing 310 and the second housing 320 in the intermediate state), the electronic device may operate in a substantially unfolded state (e.g., the unfolded state in FIG. 3A) and/or in a substantially folded state (e.g., the folded state in FIG. 3D) via the hinge device. For example, in the state of being unfolded to a predetermined inflection angle via the hinge device, when a pressing force is applied in the unfolding direction (the direction B), the electronic device 300 may be operated to transition to the unfolded state (e.g., the unfolded state in FIG. 3A). For example, in the state of being unfolded to a predetermined inflection angle via the hinge device, when a pressing force is applied in the folding direction (the direction C), the electronic device 300 may be operated to transition to the closed state (e.g., the folded state in FIG. 3D). In an embodiment of the disclosure, the electronic device 300 may be operated to maintain an unfolded state (not illustrated) at various angles via the hinge device.

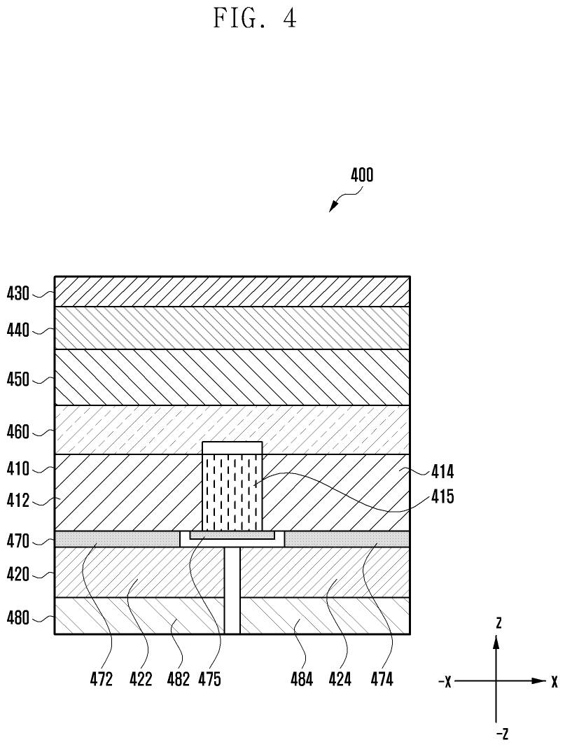

FIG. 4 illustrates a laminated structure of a display according to an embodiment of the disclosure.

According to an embodiment of the disclosure, the electronic device may be configured in a foldable structure that can be folded left and right about a vertical folding axis (e.g., the electronic device 200 in FIGS. 2A to 2D) or a foldable structure that can be folded up and down about a horizontal folding axis (e.g., the electronic device 300 in FIGS. 3A to 3E). In order to implement a foldable structure, the electronic device may include a housing structure including two housings coupled to be rotatable relative to each other (e.g., the first housing 210 and the second housing 220 in FIGS. 2A to 2D, or the first housing 310 and the second housing 320 in FIGS. 3A to 3E), and a flexible display (e.g., the first display 230 in FIGS. 2A to 2D or the flexible device 390 in FIGS. 3A to 3E).

Referring to FIG. 4, a display 400 (or a foldable display or a flexible display) may include a window layer 430, a polarizing layer 440, a display panel 450, a first polymer layer 460, a support plate 410, a digitizer 420, and a reinforcement plate 480 which are sequentially laminated in a vertical direction (or the z-axis direction). According to an embodiment of the disclosure, some of the illustrated components (e.g., the window layer 430, the polarizing layer 440, the display panel 450, and the first polymer layer 460) may be made of a flexible material and arranged across the first housing and the second housing of the electronic device, and some other components (e.g., the support plate 410, the digitizer 420, and the reinforcement plate 480) may be separately arranged to be accommodated in the first housing and the second housing, respectively.

According to an embodiment of the disclosure, the window layer 430 may be exposed outside on the front surface of the electronic device and protect the display 400 from an external impact. The window layer 430 may be made of a glass material (e.g., ultra-thin glass (UTG)) or a polymer, such as polyethylene terephthalate (PET) or polyimide (PI). According to an embodiment of the disclosure, a protection layer made of a transparent polymer (e.g., polyethylene terephthalate (PET)) to protect the window layer 430 and/or a functional coating layer including a hard coating may be provided above the window layer 430 (e.g., in the +z-axis direction).

According to an embodiment of the disclosure, the display panel 450 may include a plurality of pixels and a wiring structure (e.g., an electrode pattern). The display panel 450 may include, but is not limited to, organic light emitting diodes (OLEDs) containing organic materials.

According to an embodiment of the disclosure, the polarizing layer 440 may selectively allow light, which is output from a light source of the display panel 450 and vibrates in a predetermined direction, to pass therethrough. According to an embodiment of the disclosure, the polarizing layer 440 may be disposed between the window layer 430 and the display panel 450, or the polarizing layer 440 and the display panel 450 may be integrally configured. According to an embodiment of the disclosure, the electronic device may include, above the display panel 450, a color filter configured to output light in a predetermined wavelength band and a black matrix (BM) layer configured to prevent light leakage without including the polarizing layer 440.

According to an embodiment of the disclosure, the first polymer layer 460 may be disposed below the display panel 450 and provide a dark background to ensure visibility of the display panel 450. The first polymer layer 460 may be made of a cushioning material to provide cushioning against an impact transmitted to the display panel 450 from the outside. The first polymer layer 460 may include a barrier PI.

According to an embodiment of the disclosure, the support plate 410 may perform the function of supporting each of the components disposed on the top thereof (e.g., the polarizing layer 440, the display panel 450, and first polymer layer 460). For example, the support plate 410 may be made of a non-metallic sheet material, such as fiber reinforced plastics (FRP) (e.g., carbon fiber reinforced plastics (CFRP) or glass fiber reinforced plastics (GFRP)), having a rigid (or inflexible) property to support the display panel 450.

According to an embodiment of the disclosure, the support plate 410 may include a first support plate area 412 accommodated within the first housing of the electronic device and a second support plate area 414 accommodated within the second housing, and the first support plate area 412 and the second support plate area 414 may be maintained in a flat state when the electronic device is folded or unfolded.

According to an embodiment of the disclosure, a pattern area 415 including a plurality of openings (or recesses or holes) may be provided between the first support plate area 412 and the second support plate area 414. The pattern area 415 may include a lattice structure where support shafts (or spokes, ribs) and openings intersect with each other.

According to an embodiment of the disclosure, the first support plate area 412, the second support plate area 424, and the pattern area 415 may refer to respective areas of the support plate 410 which is a single structure. According to another embodiment of the disclosure, the first support plate area 412, the second support plate area 424, and the pattern area 415 may be separate structures that are at least partially spaced apart from each other.

According to an embodiment of the disclosure, the pattern area 415 may be located to correspond to the bending area (or the hinge structure) between the first housing and the second housing, and when the electronic device is folded or unfolded, the openings may expand or contract in size to provide elastic force.

According to an embodiment of the disclosure, the digitizer 420 may include wires to detect a touch input (or hovering input). For example, the digitizer 420 may include loop-shaped wires provided in the horizontal and vertical directions throughout the entire area of the display 400. According to an embodiment of the disclosure, the digitizer 420 may include a first digitizer area 422 accommodated in the first housing and a second digitizer area 424 accommodated in the second housing, and the wires arranged in the first and second digitizer areas 422 and 424 may not be electrically connected to each other. With this configuration, the wires of the first digitizer area 422 (or the second digitizer area 424) may be directly connected to a main printed circuit board assembly (PBA) on which the digitizer driving IC is mounted via a connector, and the wires of the second digitizer area 422 (or the first digitizer area 422) may be fastened to a sub-PBA connected to the main PBA, via a connector.

According to an embodiment of the disclosure, a first polymer layer 470 including pressure sensitive adhesive (PSA) and thermoplastic polyurethane (TPU) may be disposed between the digitizer 420 and the support plate 410. The second polymer layer 470 may include a first PSA area 472 disposed under at least a portion of the first support plate area 412 of the support plate 410, a second PSA area 472 disposed under at least a portion of the second support plate area 414, and a TPU area 475 disposed under the pattern area 415. According to an embodiment of the disclosure, the top of the TPU area 475 may be bonded to the bottom of the pattern area 415 and the bottom of portions of the first and second support plate areas 412 and 414, and the bottom of the TPU area 475 may be disposed to be spaced apart from the digitizer 420 located therebeneath by a predetermined gap. According to an embodiment of the disclosure, the height of the TPU area 475 may be substantially the same as the height of the first PSA area 472 and/or the second PSA area 474. In this case, the TPU area 475 may be bonded to the top of the digitizer 420 without a gap.

According to an embodiment of the disclosure, a reinforcement plate 480 may be disposed under the digitizer 420 to support the display 400. The reinforcement plate 480 may include a first reinforcement plate 482 accommodated in the first housing and a second reinforcement plate 484 accommodated in the second housing, and the first reinforcement plate 482 and the second reinforcement plate 484 may be separated from each other by not being disposed in the bending portion of the electronic device (e.g., under the pattern area 415).

The individual layers illustrated in FIG. 4 are not essential components for implementing various embodiments of the disclosure, and some of the layers may be omitted or replaced with other components.

In the embodiment of FIG. 4, the wires of the digitizer 420 are not arranged in the folding area of the electronic device, and the digitizer areas 412 and 414 are separated from each other and disposed in the first and second housings, respectively. With this configuration, touch detection performance may be reduced in the folding area, and since there are two lead-out portions of the connector to which the wires of the digitizer 420 are connected, there may be problems in material cost and mounting space.

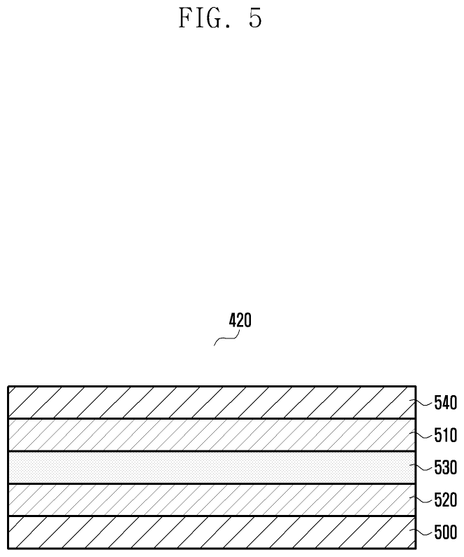

FIG. 5 illustrates a laminated structure of a digitizer according to an embodiment of the disclosure.

FIG. 5 illustrates the stacked structure of the digitizer 420 of the display 400 illustrated in FIG. 4.

According to an embodiment of the disclosure, when a touch input (or hovering input) occurs on the display 400, the digitizer 420 may detect the touch position depending on a change in electrical signal. The digitizer 420 may include wires that cover substantially the entire area of the display 400 to detect the touch position. For example, the digitizer 420 may include X-channel wires that form a loop elongated in the horizontal direction and are sequentially arranged in the vertical direction, and Y-channel wires that form a loop elongated in the vertical direction and are sequentially arranged in the horizontal direction.

Referring to FIG. 5, the digitizer 420 may include a plurality of layers. According to an embodiment of the disclosure, the digitizer 420 may include a first layer 510 on which the X-channel wires are arranged and a second layer 520 on which the Y-channel wires are arranged. Since the X-channel wires and the Y-channel wires are arranged on different layers, the X-channel wires and the Y-channel wires may cross each other in a plan view. According to an embodiment of the disclosure, the X-channel wires are not placed only in the first layer 510, and the Y-channel wires are not placed only in the second layer 520. In partial areas, the Y-channel wires may be further placed on the first layer 510, and the X-channel wires may be further placed on the second layer 520. For example, at the edge portions (e.g., the top edge, the bottom edge, the left edge, and the right edge) of the electronic device, the X-channel wires and the Y-channel wires may be mixedly arranged on the first layer 510, and/or the X-channel wires and the Y-channel wires may be mixedly arranged on the second layer 520.

According to an embodiment of the disclosure, between the first layer 510 and the second layer 520, an insulating layer (or a polymer layer) 530 to block noise between the wires of the first layer 510 and the second layer 520 may be placed. In addition, insulating layers 540 and 550 may also be disposed on the top and bottom of the first layer 510 to electrically shield components adjacent to the digitizer 420.

According to the embodiment of FIG. 5 of the disclosure, the wires of the digitizer 420 may be arranged on the two layers 510 and 520. In this case, the X-channel wires and Y-channel wires may be arranged across each other, but when additional wires are needed, there may not be enough space to arrange the additional wires. For example, when the wires of the digitizer 420 are configured to pass through the spaces between the openings in the pattern area (e.g., the pattern area 415 in FIG. 4), the number of wires that can pass through the spaces is limited since the size of the openings is inevitably limited. In this case, the two layers 510 and 520 may not be enough to arrange the wires in partial areas (e.g., near the top and bottom edges of the folding area).

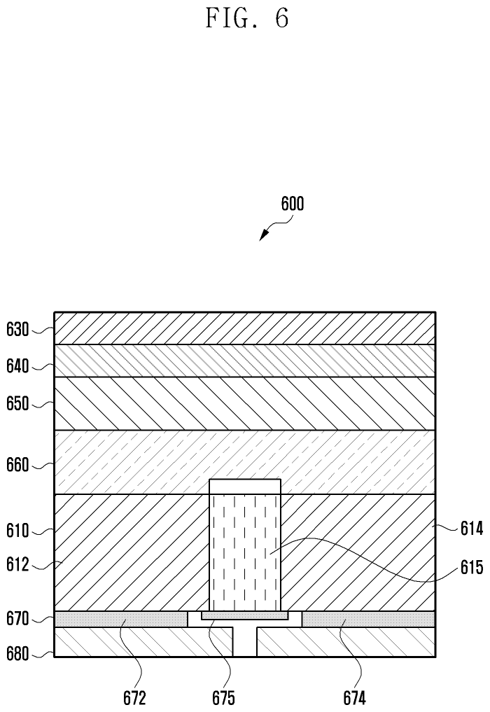

FIG. 6 illustrates a laminated structure of a display according to an embodiment of the disclosure.

According to an embodiment of the disclosure, the electronic device may be configured in a foldable structure that can be folded left and right about a vertical folding axis (e.g., the electronic device 200 in FIGS. 2A to 2D) or a foldable structure that can be folded up and down about a horizontal folding axis (e.g., the electronic device 300 in FIGS. 3A to 3E). In order to implement a foldable structure, the electronic device may include a housing structure including two housings coupled to be rotatable relative to each other (e.g., the first housing 210 and the second housing 220 in FIGS. 2A to 2D, or the first housing 310 and the second housing 320 in FIGS. 3A to 3E), and a flexible display (e.g., the first display 230 in FIGS. 2A to 2D or the flexible device 390 in FIGS. 3A to 3E).

Referring to FIG. 6, a display 600 (or a foldable display or a flexible display) may include a window layer 630, a polarizing layer 640, a display panel 650, a first polymer layer 660, a digitizer plate 610, a second polymer layer 670, and a reinforcement plate 680 which are sequentially laminated in a vertical direction (or the z-axis direction). According to an embodiment of the disclosure, some of the illustrated components (e.g., the window layer 630, the polarizing layer 640, the display panel 650, the first polymer layer 660, and the digitizer plate 610) may be at least partially made of a flexible material and arranged across the first housing and the second housing of the electronic device, and some other components (e.g., the reinforcement plate 680) may be separately arranged to be accommodated in the first housing and the second housing, respectively.

The individual layers illustrated in FIG. 6 are not essential components for implementing various embodiments of the disclosure, and some of the layers may be omitted or replaced with other components.

According to an embodiment of the disclosure, the window layer 630 may be exposed outside on the front surface of the electronic device and protect the display 600 from an external impact. The window layer 630 may be made of a glass material (e.g., ultra-thin glass (UTG)) or a polymer, such as polyethylene terephthalate (PET) or polyimide (PI). According to an embodiment of the disclosure, a protection layer made of a transparent polymer (e.g., polyethylene terephthalate (PET)) to protect the window layer 630 and/or a functional coating layer including a hard coating may be provided above the window layer 630 (e.g., in the +z-axis direction).

According to an embodiment of the disclosure, the display panel 650 may include a plurality of pixels and a wiring structure (e.g., an electrode pattern). The display panel 650 may include, but is not limited to, organic light emitting diodes (OLEDs) containing organic materials.

According to an embodiment of the disclosure, the polarizing layer 640 may selectively allow light, which is output from a light source of the display panel 650 and vibrates in a predetermined direction, to pass therethrough. According to an embodiment of the disclosure, the polarizing layer 640 may be disposed between the window layer 630 and the display panel 650, or the polarizing layer 640 and the display panel 650 may be integrally configured. According to an embodiment of the disclosure, the electronic device may include, above the display panel 650, a color filter configured to output light in a predetermined wavelength band and a black matrix (BM) layer configured to prevent light leakage without including the polarizing layer 640.

According to an embodiment of the disclosure, the first polymer layer 660 may be disposed below the display panel 650 and provide a dark background to ensure visibility of the display panel 650. The first polymer layer 660 may be made of a cushioning material to provide cushioning against an impact transmitted to the display panel 650 from the outside. The first polymer layer 660 may include a barrier PI.

According to an embodiment of the disclosure, a display 600 of an electronic device may include a digitizer plate 610 in which a support plate (e.g., the support plate 410 in FIG. 4) and a digitizer (e.g., the digitizer 420 in FIG. 4) are integrated into a single layer. For example, in the display 600, the wires of the digitizer may be arranged on a plate configured to support individual components (e.g., the polarizing layer 640, the display panel 650, and the first polymer layer 660) disposed on the top thereof. Accordingly, compared to the embodiment of FIG. 4, the adhesive layer (e.g., the second polymer layer 470 in FIG. 4) between the support plate and the digitizer may be removed, the thickness of the display 600 may be made thinner, and as the support plate and the digitizer are implemented as a single component, a weight saving effect is achieved.

According to an embodiment of the disclosure, the digitizer plate 610 has digitizer wires provided on a support plate (e.g., the support plate 610 in FIG. 4), and may also be referred to as a support plate.

According to an embodiment of the disclosure, the digitizer plate 610 may be disposed under the display panel 650 (e.g., in the −z-axis direction) and include a first plate area 612 disposed in the first housing and a second plate area 614 disposed in the second housing. The first plate area 612 and the second plate area 614 may be flat, and may be made of a non-metallic sheet material, such as fiber reinforced plastics (FRP) (e.g., carbon fiber reinforced plastics (CFRP) or glass fiber reinforced plastics (GFRP)), having a rigid (or inflexible) property to support the display panel 650.

According to an embodiment of the disclosure, a pattern area 615 corresponding to the folding area of the electronic device may be disposed between the first plate area 612 and the second plate area 614 of the digitizer plate 610. The pattern area 615 may include a lattice structure in which support shafts and openings intersect. For example, the pattern area 615 includes support shafts (or ribs) that are elongated in the y-axis direction, and openings may be provided between the support shafts. When an electronic device is folded, the distance between adjacent support shafts increases in the x-axis direction so that the size of the openings can be increased, and when the electronic device is unfolded, the distance between adjacent support shafts in the x-axis direction becomes closer so that the size of the openings can be decreased.

According to an embodiment of the disclosure, the first plate area 612, the second plate area 624, and the pattern area 615 may refer to respective areas of the digitizer plate 610 which is a single structure. According to another embodiment of the disclosure, the first plate area 612, the second plate area 624, and the pattern area 615 may be separate structures that are at least partially spaced apart from each other.

According to an embodiment of the disclosure, digitizer wires may be provided on the digitizer plate (or support plate) 610. For example, the digitizer may include loop-shaped wires arranged in the horizontal and vertical directions in the entire area of the display 600 to detect the position of a touch input (or hovering input) using a stylus (or an electronic pen). The digitizer wires may be provided as a conductive pattern of a metal material (e.g., Cu) on the digitizer plate 610. For example, the digitizer plate 610 may include X-channel wires that form a loop elongated in the horizontal direction and are sequentially arranged in the vertical direction, and Y-channel wires that form a loop elongated in the vertical direction and are sequentially arranged in the horizontal direction.

According to an embodiment of the disclosure, two or more loops of the X-channel or Y-channel wires provided on the digitizer plate 610 may configure one channel. For example, one X-channel may include two electrically connected rectangular loops elongated in the horizontal direction (or the x-axis direction), and one Y-channel may include two electrically connected rectangular loops elongated in the vertical direction (or the y-axis direction). The structure of each channel and the number of loops provided in the digitizer plate 610 are not limited thereto.

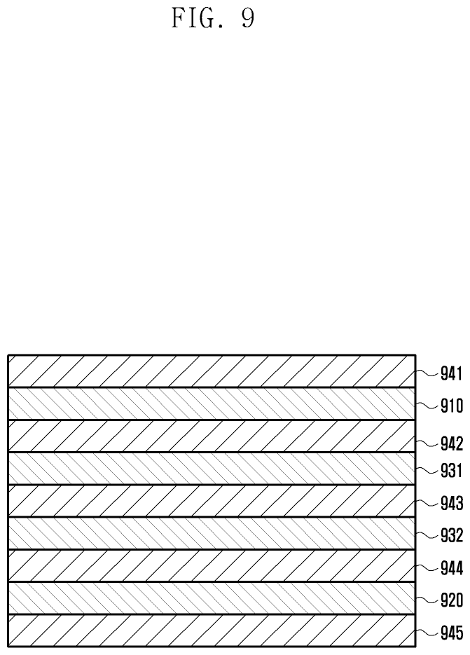

According to an embodiment of the disclosure, the digitizer plate 610 may include a plurality of layers. For example, the digitizer plate 610 may include a first layer on which X-channel wires are provided, a second layer on which Y-channel wires are provided, and at least one additional layer disposed between the first layer and the second layer. The digitizer plate 610 may include four layers, including a first layer, a second layer, and two additional layers, but the number is not limited thereto. The laminated structure of the layers of the digitizer plate 610 will be described with reference to FIG. 9.

According to an embodiment of the disclosure, the display 600 may include at least one connector connected to a digitizer driving IC. For example, one connector connected to the digitizer driving IC may be disposed in the first housing, and accordingly, at least some of the wirers of the digitizer may be electrically connected to the first plate area 612 and the second plate area 614. Alternatively, the display 600 may include two connectors connected to the digitizer driving IC, in which case the two connectors may be disposed at positions corresponding to the first plate area 612 and the second plate area 614, respectively.

According to an embodiment of the disclosure, among the wires provided on the digitizer plate (or support plate) 610, the wires provided across the first plate area 612 and the second plate area 614 may extend from the first plate area 612 to the second plate area 614 through the pattern area 615. For example, since the X-channel wires form one loop across the first plate area 612 and the second plate area 614, the wires also need to be arranged in the pattern area 615. In addition, one channel may include two or more loops, and some Y-channels include a loop formed in the first plate area 612 and a loop formed on the second plate area 614, so that a wire configured to connect each loop may pass through the pattern area 615. In addition, when the display 600 includes only one connector connected to the digitizer driving IC, a wire configured to electrically connect the Y-channel provided in the first plate area 612 or the second plate area 614 where no connector is placed to a connector may pass through the pattern area 615.

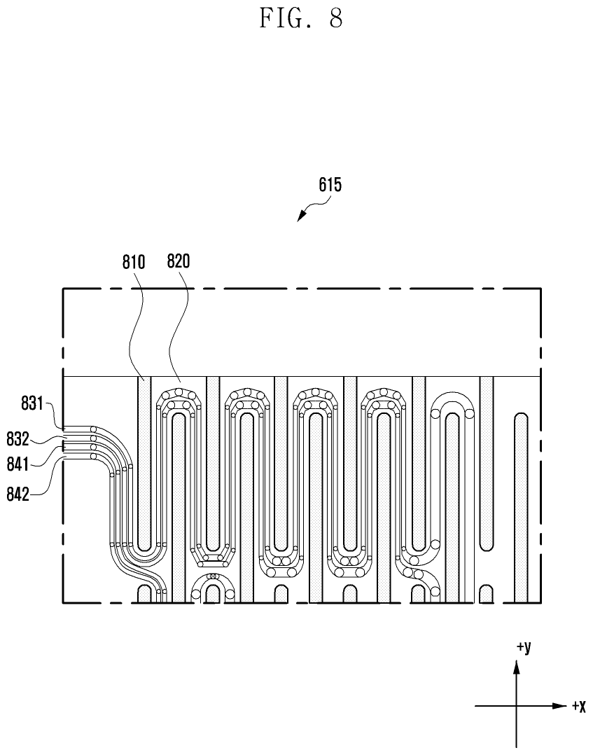

According to an embodiment of the disclosure, due to spatial constraints, the number of wires passing through the openings in the pattern area 615 may be limited. Accordingly, in the case of the X-channel wires provided in the first layer, some wires may be passed through the first layer to be passed through the pattern area 615, and some other wires may be passed through at least one additional layer between the first layer and the second layer. In addition, in the case of the Y-channel wires provided in the second layer, some wires may be passed through the second layer to be passed through the pattern area 615, and some other wires may be passed through at least one additional layer between the first layer and the second layer. The structure in which wires are provided on the pattern area 615 will be described with reference to FIG. 8.

According to an embodiment of the disclosure, a second polymer layer 670 including pressure sensitive adhesive (PSA) and thermoplastic polyurethane (TPU) may be disposed under the digitizer plate 610. The second polymer layer 670 may include a first PSA area 672 disposed under at least a portion of the first plate area 612 of the digitizer plate 610, a second PSA area 674 disposed under at least a portion of the second plate area 614, and a TPU area 675 disposed under the pattern area 615. According to an embodiment of the disclosure, the top of the TPU area 675 may be bonded to the bottom of the pattern area 615 and the bottom of portions of the first and second plate areas 612 and 614, and the bottom of the TPU area 675 may be disposed to be spaced apart from the reinforcement plate 680 located therebeneath by a predetermined gap. According to an embodiment of the disclosure, the height of the TPU area 675 may be substantially the same as the height of the first PSA area 672 and/or the second PSA area 674. In this case, the TPU area 675 may be bonded to the top of the reinforcement plate 680 without a gap.

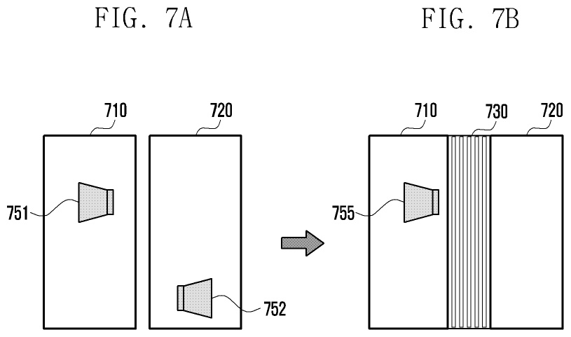

FIGS. 7A and 7B illustrate a connector connected to a digitizer driving IC according to an embodiment of the disclosure.

Referring to FIGS. 7A and 7B, according to an embodiment of the disclosure, the electronic device may include a digitizer configured to detect a touch input or hovering input using a stylus or a user's finger. The digitizer may include a plurality of wires forming loops at predetermined intervals, and may detect the position of a touch input depending on an electrical signal detected from each wire.

According to an embodiment of the disclosure, the digitizer driving IC may output a driving signal to the wires of a driving channel and receive an electrical signal detected from the wires of a receiving channel. The digitizer driving IC may be placed on the main printed circuit board assembly (PBA) and electrically connected to the wires of the digitizer via a connector.

Referring to FIG. 7A, it illustrates an embodiment in which a foldable type electronic device includes two connectors 751 and 752 connected to a display driving IC. For example, as described above with reference to FIG. 4, the digitizer 420 may include a first digitizer area 710 accommodated in the first housing and a second digitizer area 720 accommodated in the second housing, and the wires arranged in the first digitizer area 710 and the second digitizer area 720 may not be electrically connected to each other. With this configuration, the wires in the first digitizer area 710 may be directly connected to the main PBA on which the digitizer driving IC is mounted via a first connector 751, and the wires in the second digitizer area 720 may be connected to a sub-PBA connected to the main PBA via the second connector 752.

Referring to FIG. 7B, it illustrates an embodiment in which a foldable type electronic device includes one connector 755 connected to a display driving IC. Referring to FIG. 7B, the connector 755 connected to the digitizer driving IC may be disposed in the first housing, but may not be disposed in the second housing.

According to an embodiment of the disclosure, a display of an electronic device may include a digitizer plate (e.g., the digitizer plate 610 in FIG. 6) in which a support plate (e.g., the support plate 410 in FIG. 4) and a digitizer (e.g., the digitizer 420 in FIG. 4) are integrated into a single layer. The wires of the digitizer may be provided on the digitizer plate. In this way, when the wires are provided on the digitizer plate and only one connector connected to the digitizer driving IC is placed on the digitizer plate, some of the wires of the digitizer may be arranged across the first plate 710 and the second plate 720. For example, the X-channel wires forming a loop elongated in the horizontal direction may form a single loop across the first plate 710 and the second plate 720, and the Y-channel wires provided on the second plate 720 need to extend to the first plate 710 for connection with a connector.

According to an embodiment of the disclosure, among the wires provided on the digitizer plate, the wires provided across the first plate 710 and the second plate 720 may extend from the first plate 710 to the second plate 720 through the pattern area 730.

FIG. 8 illustrates wires passing through a pattern area (or a lattice structure) according to an embodiment of the disclosure.

According to an embodiment of the disclosure, the electronic device may be a fully foldable electronic device (e.g., the electronic device 200 in FIGS. 2A to 2D or the electronic device 300 in FIGS. 3A to 3E). A display of an electronic device may include a digitizer plate (e.g., the digitizer plate 610 in FIG. 6) in which a support plate (e.g., the support plate 410 in FIG. 4) and a digitizer (e.g., the digitizer 420 in FIG. 4) are integrated into a single layer.

According to an embodiment of the disclosure, among the wires provided on the digitizer plate, the wires provided across the first plate area (e.g., the first plate area 612 in FIG. 6) and the second plate area (e.g., the second plate area 614 in FIG. 6) may extend from the first plate area to the second plate area through the pattern area 615 (e.g., the pattern area 615 in FIG. 6). For example, since the X-channel wires form one loop across the first plate area and the second plate area, wires also need to be placed on the pattern area 615, and some of the Y-channel wires may also pass through the pattern area 615 in narrow sections at the top and bottom edges. In addition, one channel may include two loops, some Y-channels may include at least one loop provided on the pattern area 615. Alternatively, since some Y-channels may include a loop formed on the first plate area and a lop formed on the second plate area, a wire to connect each loop may pass through the pattern area 615. In addition, the display may include only one connector connected to the digitizer driving IC. In this case, a wire configured to electrically connect the Y-channel provided in the first plate area or the second plate area where no connector is placed to a connector may pass through the pattern area 615.

Referring to FIG. 8, the pattern area 615 may include support shafts 820 (or ribs) elongated in the y-axis direction, and openings 810 (or recesses) may be provided between the support shafts 820. Individual support shafts 820 may be spaced apart from each other by a predetermined interval in the x-axis direction, and the distance between adjacent support shafts 820 may vary when the electronic device is folded or unfolded. The individual support shafts 820 may be arranged to be staggered, so that the spatial path defined by the openings 810 may be a winding path. Accordingly, the wires 831, 832, 841, and 842 passing through the pattern area 615 may be in the form of a serpentine pattern following the spatial path defined by the support shafts 820.

According to an embodiment of the disclosure, only a predetermined number or less of wires may pass through the winding spatial path defined on the support shafts 820 due to the openings 810 of the pattern area 615. For example, as the support shafts 820 of the pattern area 615 becomes thicker, the repulsive force increases, and the folding property of the electronic device may deteriorate, which may make it difficult to greatly adjust the width (e.g., the width in the x-axis direction or y-axis direction) of the support shafts 820. In addition, it is not easy to secure the width of the support shafts by reducing the size of the openings within a predetermined space during the manufacturing process, and there may be a limitation in reducing the thickness of the wires. FIG. 8 illustrates that two wires can pass through one spatial path defined by the openings 810 in the pattern area 615, but the number is not limited thereto.

According to an embodiment of the disclosure, in order to resolve the above-mentioned spatial constraints in the electronic device, the digitizer plate (or support plate) may be configured by a plurality of (e.g., four) layers. For example, the digitizer plate may include a first layer, a second layer, and at least one additional layer, which are sequentially laminated in the z-axis direction. In the case of the X-channel wires provided in the first layer, some wires may be passed through the first layer to be passed through the pattern area 615, and some other wires may be passed through at least one additional layer between the first layer and the second layer. In addition, in the case of the Y-channel wires provided in the second layer, some wires may be passed through the second layer to be passed through the pattern area 615, and some other wires may be passed through at least one additional layer between the first layer and the second layer.

According to an embodiment of the disclosure, the wires 831, 832, 841, and 842 of the digitizer may be fabricated as winding wires to follow the winding spatial path defined on the support shafts 820 by the openings 810 in the pattern area 615. Accordingly, the resistance of the wires 831, 832, 841, and 842 of the digitizer may increase, and when the resistance of the wires increases, it is necessary to lower the driving current, which may deteriorate touch recognition performance.

According to an embodiment of the disclosure, the electronic device may include additional wires electrically connected to at least some of the wires 831, 832, 841, and 842 of the digitizer. According to an embodiment of the disclosure, the additional wires may be arranged on at least one additional layer of the digitizer plate (or support plate), and may be arranged in the area where the X-channel or Y-channel wires are not provided in the additional layer of the first plate area or the second plate area. According to another embodiment of the disclosure, the additional wires may be arranged on at least one additional layer in the pattern area of the digitizer plate (or support plate), and may be arranged in an area where the X-channel or Y-channel wires are not provided in the additional layer of the pattern area. The additional wires may be connected in parallel with the digitizer wires, and as a result, the resistance of the digitizer wires can be reduced.

FIG. 9 illustrates a laminated structure of a digitizer plate according to an embodiment of the disclosure.

FIG. 9 illustrates the laminated structure of the digitizer of the display illustrated in FIG. 6.

According to an embodiment of the disclosure, the wires of the digitizer may be formed on a digitizer plate (e.g., the digitizer plate 610 in FIG. 6). For example, the digitizer may include X-channel wires that form a loop elongated in the horizontal direction and are sequentially arranged in the vertical direction, and Y-channel wires that form a loop elongated in the vertical direction and are sequentially arranged in the horizontal direction. The digitizer plate may also be referred to as a support plate.

According to an embodiment of the disclosure, the digitizer plate may include a plurality of layers. For example, the plurality of layers may include a first layer 910 and a second layer 920 on which the wires of the digitizer are provided, and one or more additional layers 931 and 932. Digitizer wires and/or additional wires may be provided in respective layers.

According to an embodiment of the disclosure, the plurality of layers may be provided substantially in parallel to each other (e.g., the XY plane) in a first plate area (e.g., the first plate area 612 in FIG. 6) disposed in the first housing, a second plate area (e.g., the second plate area 614 in FIG. 6) disposed in the second housing, and a pattern area (e.g., the pattern area 615 in FIG. 6).

According to an embodiment of the disclosure, an insulating layer 942, 943, or 944 may be disposed between each adjacent layers. For example, the insulating layers may be made of an insulating material, such as glass fiber reinforced plastics (GFRP). The insulating layer may also be referred to as a GFRP layer. With the arrangement of the insulating layers, noise (e.g., cross talk) caused by wires in adjacent layers can be reduced. Additionally, insulating layers 941 and 945 may be disposed on the top of the first layer 910 and the bottom of the second layer 920.

According to an embodiment of the disclosure, the first layer 910 may be disposed in the +z-axis direction from the second layer 920, and X-channel wires may be provided on the first layer 910. The second layer 920 may be disposed in the −z-axis direction from the first layer 910, and Y-channel wires may be provided on the second layer 920. Since the X-channel wires and the Y-channel wires are arranged in different layers, the X-channel wires forming a loop elongated in the x-axis direction and the Y-channel wires forming a loop elongated in the y-axis direction may cross each other.

According to an embodiment of the disclosure, at least one additional layer 931 or 932 may be disposed between the first layer 910 and the second layer 920. FIG. 9 illustrates that a first additional layer 931 and a second additional layer 932 are disposed, but the number of additional layers is not limited thereto. According to an embodiment of the disclosure, an insulating layer 943 made of an insulating material, such as glass fiber reinforced plastics (GFRP) may be disposed between the first additional layer 931 and the second additional layer 932.

According to an embodiment of the disclosure, at least some of the X-channel wires and Y-channel wires may pass through the at least one additional layer 931 or 932 of the pattern area. For example, the X-channel wires provided in the first layer 910 may form a loop across the first plate area and the second plate area, which allows the wires to pass through the pattern area. In addition, since some Y channels include at least one loop formed on the pattern area, or include a loop formed on the first plate area and a loop formed on the second plate area, a wire to connect each loop may pass through the pattern area. In addition, the electronic device may include only one connector connected to the digitizer driving IC. In this case, a wire configured to electrically connect the Y channel provided in the plate area where the connector connected to the digitizer driving IC is not placed to a connector may pass through the pattern area.

As described above, when the wires of the digitizer are arranged to pass through the pattern area, there may be many wires to pass through in a partial area of the pattern area. For example, many wires need to be passed through the edge areas of the pattern area (e.g., near the top and bottom edges in the y-axis direction) and an area parallel to the connector. However, as described above with reference to FIG. 8, the number of wires passing through the openings of the pattern area may be limited.

According to an embodiment of the disclosure, the X-channel wires of the first layer 910 may be configured such that some of the X-channel wires are provided on the first layer 910, and others are provided on at least one additional layer 931 or 932. For example, when it is necessary to make four X-channel wires pass through a specific area (e.g., an edge area or an area parallel to the connector) of the pattern area, two wires may be provided on the first layer 910 in the pattern area, and the remaining two wires may be provided on a first additional layer 931 under the first layer 910. According to an embodiment of the disclosure, the Y-channel wires of the second layer 920 may be configured such that some of the Y-channel wires are provided on the second layer 920 of the pattern area, and others are provided on the at least one additional layer 931 or 932. For example, if it is necessary to make four Y-channel wires pass through a specific area (e.g., an edge area or an area parallel to the connector) of the pattern area, two wires may be provided on the second layer 920, and the remaining two wires may be provided on a second additional layer 932 above the second layer 920.

According to an embodiment of the disclosure, the wires of the digitizer may be provided only in a partial area of the at least one additional layer 931 or 932. As described above, on the first additional layer 931 and the second additional layer 932, the wires of the digitizer may be provided in a pattern area, a connector, or an area adjacent thereto, and the wires of the digitizer may not be provided in many areas on the first plate area and the second plate area.

According to an embodiment of the disclosure, at least one additional wire electrically connected to the wires of the digitizer may be arranged in at least some of the areas where the wires of the digitizer are not provided in the at least one additional layer 931 or 932. Here, the additional wire may be intended to reduce the resistance of the wires of the digitizer. For example, some of the wires of the digitizer may be provided in a winding shape to pass through the pattern area, and as a result, the wires may be designed to have an increased length and a narrowed width, which may cause the wires to have high resistance. In the electronic device, the resistance of the wires of the digitizer may be reduced by arranging additional wires connected in parallel to the wires of the digitizer.

According to an embodiment of the disclosure, at least some of the wires provided on each layer may be connected to each other through vias. For example, additional wires provided on the additional layers 931 and 932 may be connected to the wires of the digitizer on the first layer 910 or the second layer 920 through vias.

The arrangement order of each layer and the type of wires arranged on each layer are not limited to those illustrated in FIG. 9. For example, the Y-channel wires may be arranged on the first layer 910 placed in the +z-axis direction, and the X-channel wires may be arranged on the second layer 920 placed in the −z-axis direction, and/or at least one of the additional layers 931 and 932 may be disposed outside the first layer 910 and the second layer 920 (e.g., in the +z-axis direction of the first layer or in the −z-axis direction of the second layer).

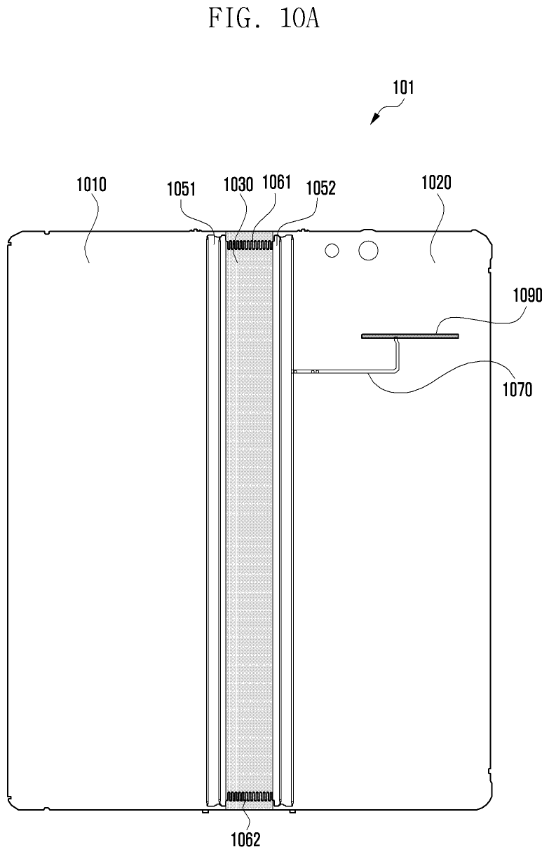

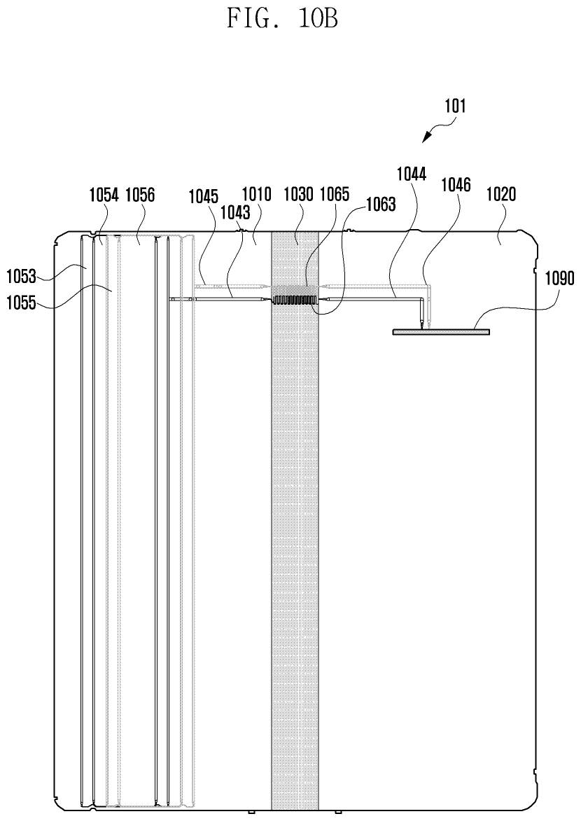

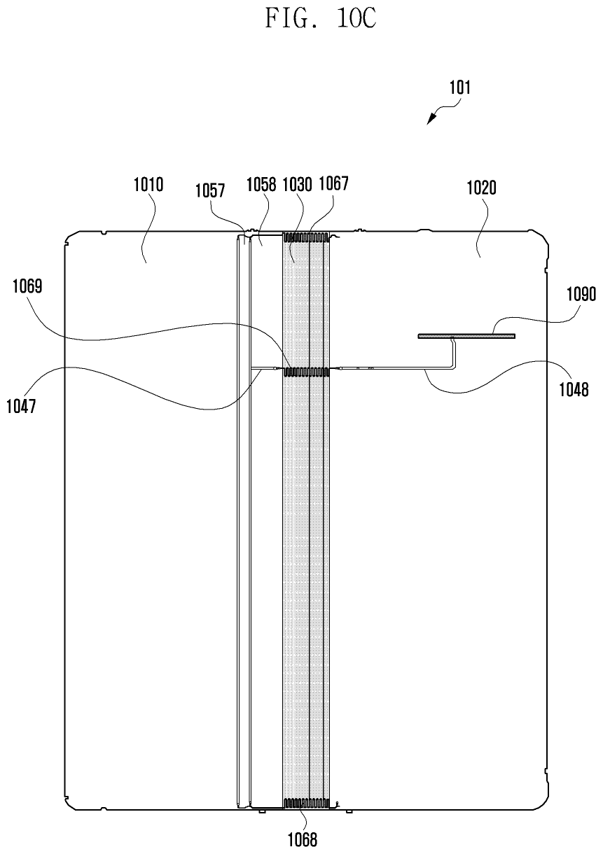

FIGS. 10A, 10B, and 10C illustrate Y-channel wires provided on a digitizer plate according to various embodiments of the disclosure.

According to an embodiment of the disclosure, a display of an electronic device 101 may include a digitizer plate in which a polarizing layer, a support plate configured to support components disposed on the top thereof, such as a display panel, and a digitizer including wires to detect a touch input are integrated into a single layer. The digitizer plate refers to that obtained by providing the wires of the digitizer on a support plate, and may also be referred to as a support plate. The digitizer plate may include a first plate area 1010 (e.g., the first plate area 610 in FIG. 6) disposed in the first housing, a second plate area 1020 (e.g., the second plate area 620 in FIG. 6) disposed in the second housing, and a pattern area 1030 provided between the first plate area 1010 and the second plate area 1020.

FIGS. 10A, 10B, and 10C illustrate wires provided on a digitizer plate (e.g., the digitizer plate 610 in FIG. 6) with reference to a front surface of an electronic device 101.

According to an embodiment of the disclosure, Y-channel wires including a loop elongated in the vertical direction may be provided on the digitizer plate. Each Y-channel may include at least one loop, and, for example, as illustrated in FIG. 10A, one Y-channel may form a first loop 1051, which is relatively a large rectangular wire, and a second loop 1052, which is a relatively small rectangular wire, in the first loop 1051.

According to an embodiment of the disclosure, a specific Y channel may include two loops 1051 and 1052 arranged across the first plate area 1010 and the second plate area 1020. Referring to FIG. 10A, wires 1061 and 1062 interconnecting a wire arranged in the first plate area 1010 from the first loop 1051 and the second loop 1052 and a wire arranged in the second plate area 1020 from the first loop 1051 and the second loop 1052 may be arranged through the top and bottom edge areas of the pattern area 1030.

According to an embodiment of the disclosure, the Y-channel wires may be provided on a second layer (e.g., the second layer 920 in FIG. 9) of the digitizer plate. According to an embodiment of the disclosure, among the Y-channel wires, the wires passing through the pattern area 1030 may be provided on at least one additional layer (or the second additional layer 932) between the first layer and the second layer. For example, due to spatial constraints of the support shafts (or spokes) of the pattern area 1030, the number of wires passing through the pattern area 1030 may be limited, and in the edge areas, there may be insufficient spaces to provide all of the Y-channel wires on the second layer. Accordingly, in the corresponding areas, the Y-channel wires may be formed on the at least one additional layer and connected to the Y-channel wires provided in the first layer through via through (or via hole).

According to an embodiment of the disclosure, a wire 1070 interconnecting a Y-channel loop 1052 and a connector 1090 may also be provided on an additional layer to avoid the X-channel wires and the Y-channel wires.

According to an embodiment of the disclosure, the electronic device 101 may include at least one connector interconnecting the wires of the digitizer plate (or support plate) and a main PBA on which a digitizer driving IC is mounted. FIG. 10B illustrates an arrangement structure of Y-channel wires provided on the first plate area 1010 when one connector 1090 is disposed on the second housing.

Referring to FIG. 10B, a connector 1090 for connection to the main PBA may be disposed at a location of the second plate area 1020. Each channel provided on the digitizer plate may be electrically connected to the connector 1090.

Referring to FIG. 10B, Channel Y02 and Channel Y03 may be provided on the first plate 1010. For example, Channel Y02 and Channel Y03 may each include two loops, in which a second loop 1054 of Channel Y02 may be provided within a first loop 1053 of Channel Y02, a second channel of Channel Y03 may be provided within a first channel of Channel Y03, and the individual loops 1053, 1054, 1055, and 1056 may at least partially overlap each other.

According to an embodiment of the disclosure, wires to connect the wires of Channel Y02 to the connector 1090 and wires to connect the wires of Channel Y03 to the connector 1090 may be formed on the digitizer plate. For example, the wires extending from Channel Y02 may be connected to a wire 1043 provided in the first plate area 1010, a wire 1063 passing through the pattern area 1030, and a wire 1044 provided in the second plate area 1020 to be connected to the connector 1090. In addition, the wires extending from Channel Y03 may be connected to a wire 1045 provided in the first plate area 1010, a wire 1065 passing through the pattern area 1030, and a wire 1046 provided in the second plate area 1020 to be connected to the connector 1090.

According to an embodiment of the disclosure, the wires 1043, 1063, 1044, 1045, 1065, and 1046 to connect the wires of Channel Y02 and Channel Y03 to the connector 1090 may be arranged on at least one additional layer between the first layer and the second layer. For example, the wires 1043, 1063, and 1044 extending from Channel Y02 and the wires 1045, 1065, and 1046 extending from Channel Y03 may each be provided on a second additional layer and may be arranged adjacent to each other in the y-axis direction.

According to an embodiment of the disclosure, at least one wire constituting a Y-channel may be provided on the pattern area 1030.

Referring to FIG. 10C, Channel Y08 may include two loops 1057 and 1058, and a portion of the wire of each loop may be arranged on the pattern area 1030. According to an embodiment of the disclosure, the wires 1067 and 1068 of each loop may be provided as winding wires at the top and bottom of the pattern area 1030, and in order to connect the wires of the second loop 1058 of the first plate area 1010 to the connector 1090, a wire 1047 may be provided on the first plate area 1010, a wire 1069 may be provided on the pattern area, and a wire 1048 may be provided on the second plate area 1020.

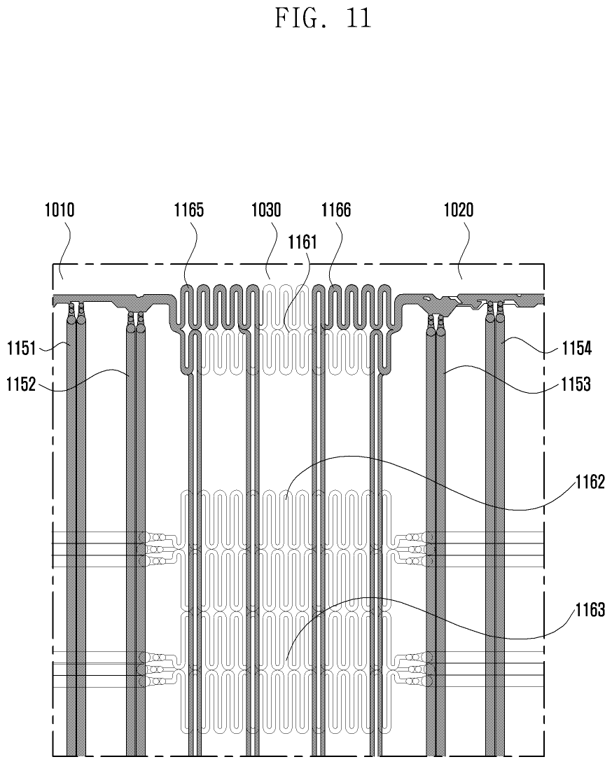

FIG. 11 illustrates wires provided on a second layer and an additional layer of a top edge area of an electronic device in a pattern area according to an embodiment of the disclosure.

Referring to FIG. 11, the wires illustrated with the dark color may be the wires provided on the second layer, and the wires illustrated with the transparent color may be the wires provided in an additional layer (e.g., a second additional layer).

Referring to FIG. 11, in the first plate area 1010, specific Y-channel wires 1151 and 1152 may be provided on the second layer, and in the second plate area 1020, specific Y-channel wires 1153 and 1154 may be provided. For example, each Y-channel may include two loops of a first loop, which is a relatively large rectangular wire, and a second loop, which is a relatively small rectangular wire within the first loop. The number and forms of loops constituting the Y-channel are not limited thereto.

According to an embodiment of the disclosure, specific Y-channel wires may be provided in the pattern area 1030 (or a lattice structure). Referring to FIG. 11, four loops of wires 1141, 1142, 1143, and 1144 may be provided on the pattern area 1030.

According to an embodiment of the disclosure, at least some of the Y-channel wires of the first plate area 1010 may be provided on an additional layer in an edge area. For example, in FIG. 11, at least one of the first wire 1151 and the second wire 1152 may be provided on the additional layer in the top edge area. The wires provided on the second layer and the additional layer in an edge area may extend through the wire 1065 provided in a winding path in the pattern area 1030. According to an embodiment of the disclosure, at least some of the Y-channel wires of the second plate area 1020 may be provided on an additional layer in an edge area. For example, in FIG. 11, at least one of the third wire 1153 and the fourth wire 1154 may be provided on the additional layer in the top edge area. The wires provided on the second layer and the additional layer in an edge area may extend through the wire 1165 and 1166 provided in a winding path in the pattern area 1030. In addition, on the additional layer, Y-channel wires 1161 may be provided across the first plate area 1010 and the second plate area 1020 in the top edge area, and wires 1162 and 1163 extending from other wires (e.g., wires to be connected to a connector) may be provided in the x-axis direction.

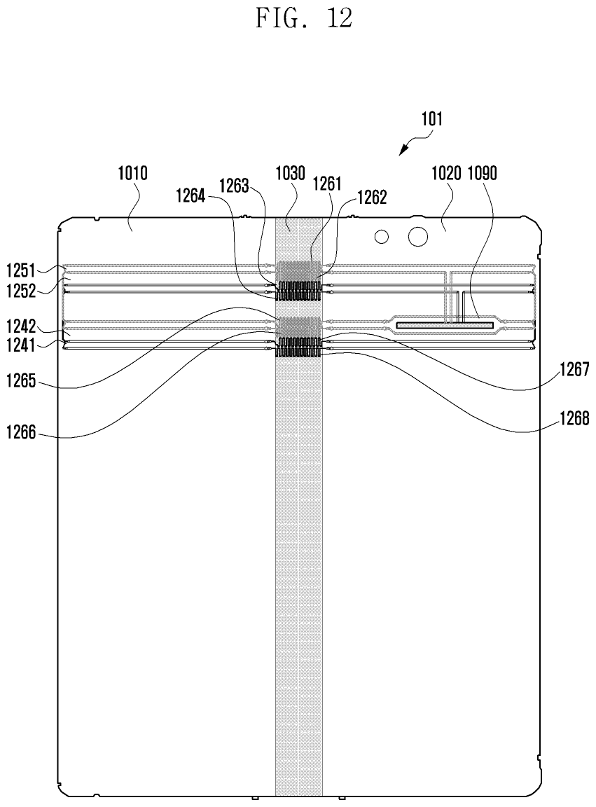

FIG. 12 illustrates X-channel wires provided on a digitizer plate according to an embodiment of the disclosure.

FIG. 12 illustrates some of X-channel wires provided on a digitizer plate (or support plate) with reference to the front surface of an electronic device.

According to an embodiment of the disclosure, X-channel wires including a loop elongated in the horizontal direction may be provided on the digitizer plate. Each X channel may include at least one loop. For example, one X-channel may include two loops, as illustrated in FIG. 12.

According to an embodiment of the disclosure, an electronic device 101 may include at least one connector 1090 that connects the wires of the digitizer plate to a main PBA on which a digitizer driving IC is mounted. Referring to FIG. 12, one connector 1090 for connection to the main PBA may be disposed at a location of the second plate area 1020.

Referring to FIG. 12, Channel X19 and Channel X20 may be provided across the first plate area 1010 and the second plate area 1020. For example, Channel X19 and Channel X20 may each include two loops, in which, in Channel X19, a second loop 1252 may be provided within a first loop 1251, in Channel X20, a second channel 1242 may be provided within a first channel 1241, and the individual loops 1251, 1252, 1241, and 1242 may at least partially overlap each other. Because Channel X19 and Channel X20 are arranged throughout the first plate area 1010 and the second plate area 1020, each of a wire 1261 extending from the top wire of the first loop 1251 of Channel X19, a wire 1262 extending from the top wire of the second loop 1252 of Channel X19, a wire 1263 extending from the top wire of the first loop 1241 of Channel X20, a wire 1264 extending from the top wire of the second loop 1242 of Channel X20, a wire 1265 extending from the bottom wire of the second loop 1252 of Channel X19, a wire 1266 extending from the bottom wire of the first loop 1251 of Channel X19, a wire 1267 extending from the bottom wire of the second loop 1242 of Channel X20, and a wire 1268 extending from the bottom wire of the first loop 1241 of Channel X20 may be provided on a winding path of the pattern area 1030.

According to an embodiment of the disclosure, a wire to connect at least one X-channel to a connector 1090 may be provided on at least one additional layer. For example, a wire to connect the second loop 1252 of Channel X19 to the connector 1090 and a wire to connect the second loop 1242 of Channel X20 to the connector 1090 may each be provided on the first additional layer, and may be arranged adjacent to each other in the x-axis direction.

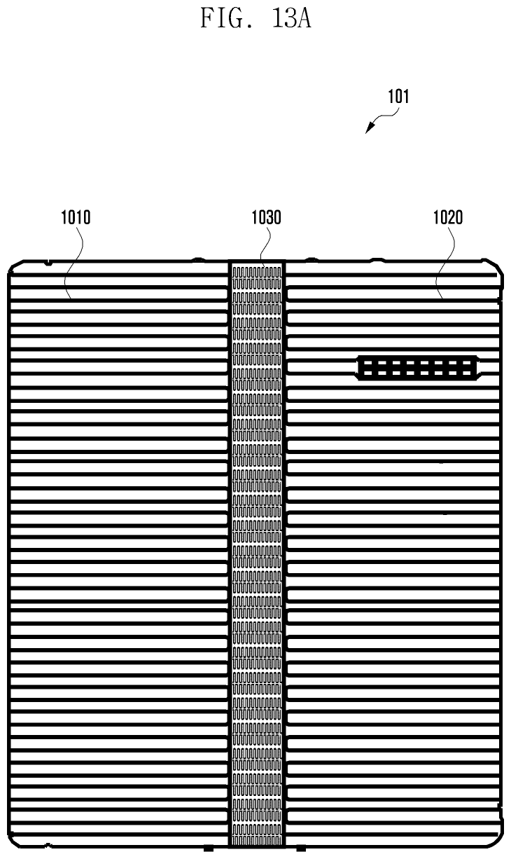

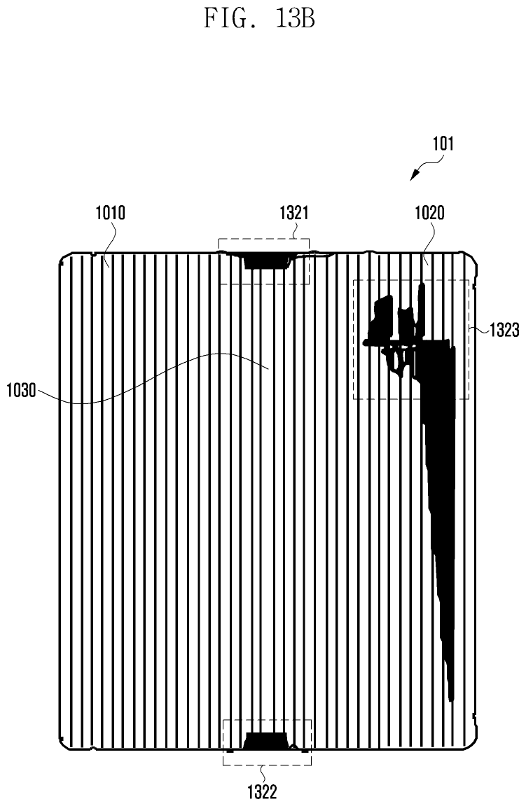

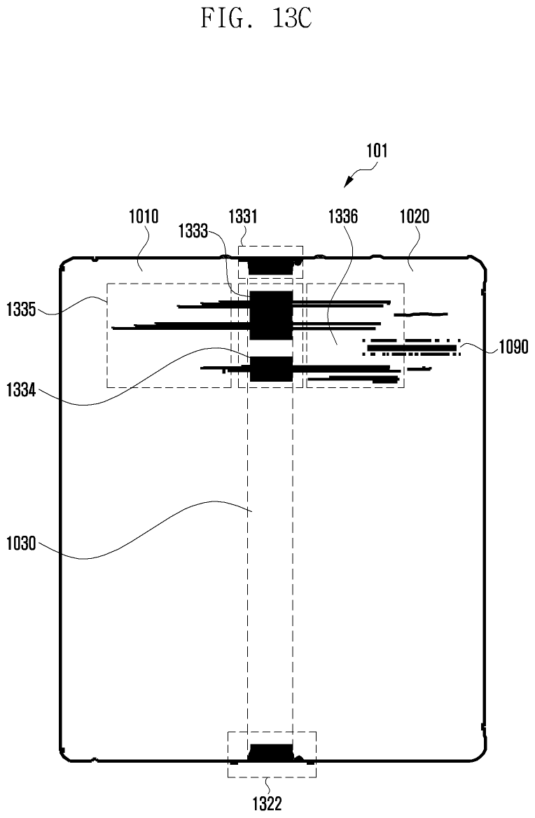

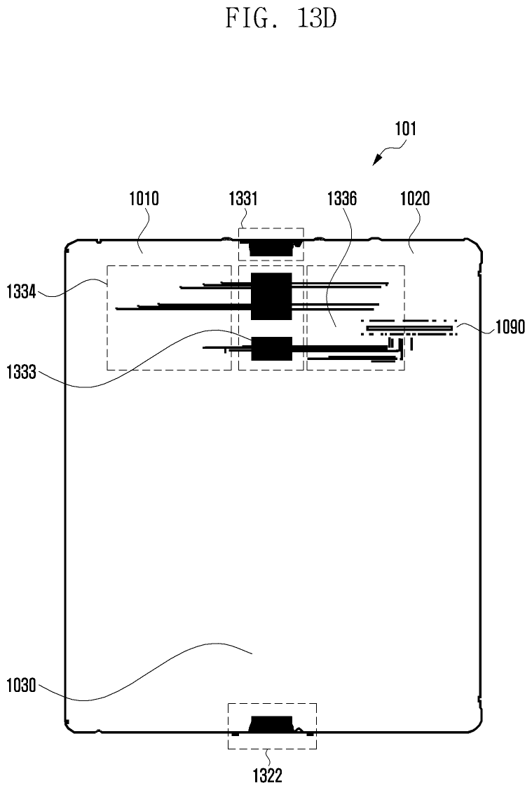

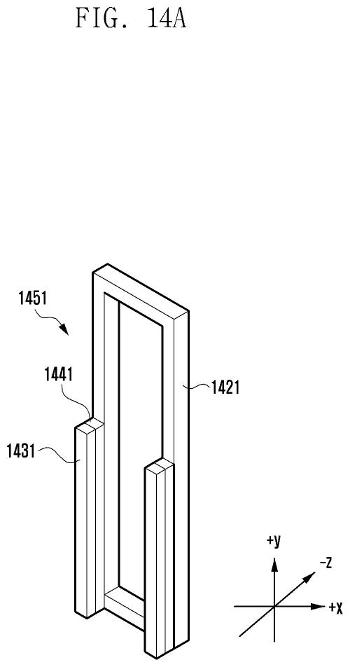

FIGS. 13A, 13B, 13C, and 13D illustrate wires provided on a plurality of layers of a digitizer plate according to various embodiments of the disclosure.

According to an embodiment of the disclosure, a digitizer plate (e.g., the digitizer plate 610 of FIG. 6) (or support plate) of an electronic device 101 may include a plurality of layers. For example, the digitizer plate may include a first layer (e.g., the first layer 910 in FIG. 9) on which X-channel wires are provided, a second layer (e.g., the second layer 920 in FIG. 9) on which Y-channel wires may be provided, and at least one additional layer disposed between the first layer and the second layer, in which the at least one additional layer may include a first additional layer (e.g., the first additional layer 931 in FIG. 9) and a second additional layer (e.g., the first additional layer 931 in FIG. 9). FIG. 13A illustrates the wires of the digitizer arranged on the first layer, FIG. 13B illustrates the wires of the digitizer arranged on the second layer, FIG. 13C illustrates the wires of the digitizer arranged on the first additional layer, and FIG. 13D illustrates the wires arranged on the second additional layer.

Referring to FIG. 13A, the X-channel wires including loops elongated in the horizontal direction may be arranged on the first layer of the digitizer plate. The loops of the X channel wires may be provided across the first plate area 1010 and the second plate area 1020, and provided on the support shafts of the pattern area 1030 to pass through the pattern area 1030. Each X-channel may include two loops elongated in the x-axis direction, for example, a first loop that is a relatively large rectangular wire and a second loop that is a relatively small rectangular wire within the first loop. The number and shapes of loops formed by the X-channel wires are not limited thereto.

Referring to FIG. 13B, the Y-channel wires including loops elongated in the vertical direction may be arranged on the second layer of the digitizer plate. According to an embodiment of the disclosure, each Y-channel may include two loops elongated in the y-axis direction, for example, a first loop that is a relatively large rectangular wire and a second loop that is a relatively small rectangular wire within the first loop. The number and shapes of loops formed by the Y-channel wires are not limited thereto.

According to an embodiment of the disclosure, the Y-channel wires may be concentrated in a partial area of the digitizer plate. Referring to FIG. 13B, a plurality of wires to pass through the pattern area 1030 may be arranged in the top edge area 1321 and the bottom edge area 1322 of the pattern area 1030. In addition, a plurality of Y-channel wires may be arranged in an area 1323 adjacent to the connector 1090 disposed in the second plate area 1020.

According to an embodiment of the disclosure, the first additional layer may be disposed between the first additional layer and the second additional layer, and the second additional layer may be disposed between the first additional layer and the second layer. The X-channel wires and/or the Y-channel wires may be arranged in partial areas of the first additional layer and the second additional layer.

Referring to FIG. 13C, the X-channel wires and/or the Y-channel wires may be arranged in the top edge area 1331 and the bottom edge area 1332 of the pattern area 1030 in the first additional layer. A plurality of wires extending from the first plate area 1010 to the second plate area 1020 may be concentrated in the top edge area 1331 and the bottom edge area 1332 of the pattern area 1030. As described above with reference to FIG. 8, the number of wires that can be provided on the support shafts (or spokes) of the pattern area 1030 in one layer and pass through the pattern area 1030 may be inevitably limited due to spatial constraints. Accordingly, in the edge areas 1331 and 1332, at least some of the X-channel wires of the first layer and/or the Y-channel wires of the second layer may be arranged on the first additional layer and/or the second additional layer when passing through the pattern area 1030.

In addition, referring to FIG. 13C, in the first additional layer, the X-channel wires and/or the Y-channel wires may be arranged in an area 1335 adjacent to the connector 1090 of the first plate area 1010, a partial area 1334 of the pattern area 1030, and a partial area 1336 of the second plate area 1020. According to an embodiment of the disclosure, an electronic device 101 may include one connector 1090 connecting the wires of a digitizer plate to a main PBA on which a digitizer driving IC is mounted. Referring to FIG. 13C, the connector 1090 may be disposed on the second plate area 1020. Wires may be needed to connect some of the X-channel wires and/or the Y-channel wires to the connector 1090, and the corresponding wires may be arranged in a partial area of the first plate area 1010, a partial area of the pattern area 1030, and a partial area of the second plate area 1020 adjacent to the connector 1090 in the first additional layer.

Referring to FIG. 13D, the X-channel wires and/or the Y-channel wires may be arranged in the top edge area and the bottom edge area of the pattern area 1030 in the second additional layer. In addition, wires to connect some of the X-channel wires and/or the Y-channel wires to the connector 1090 may be arranged in a partial area 1334 of the first plate area 1010, a partial area 1333 of the pattern area 1030, and a partial area 1336 of the second plate area 1020 adjacent to the connector 1090 in the second additional layer.

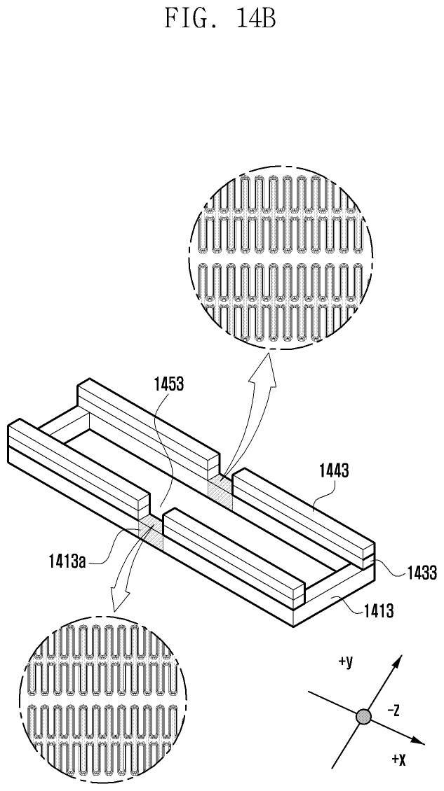

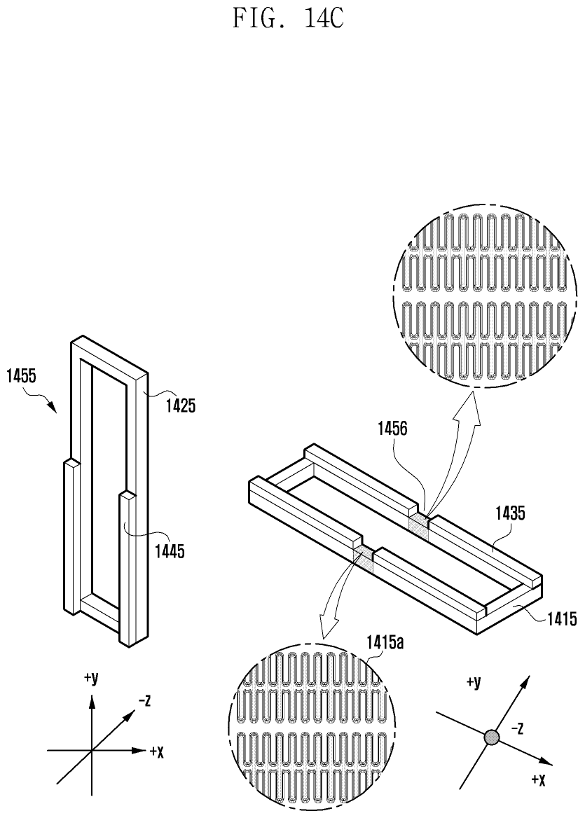

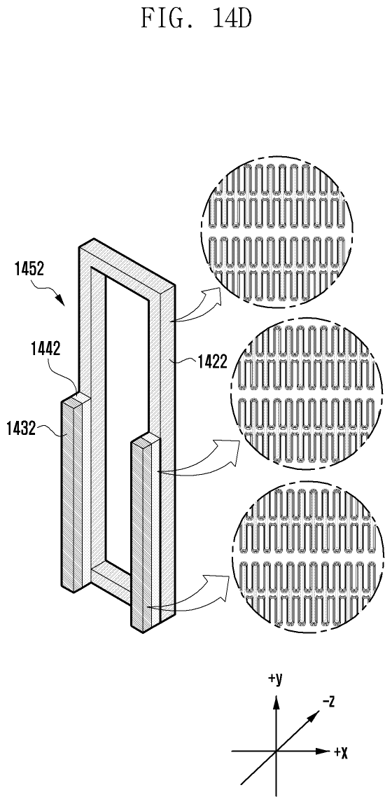

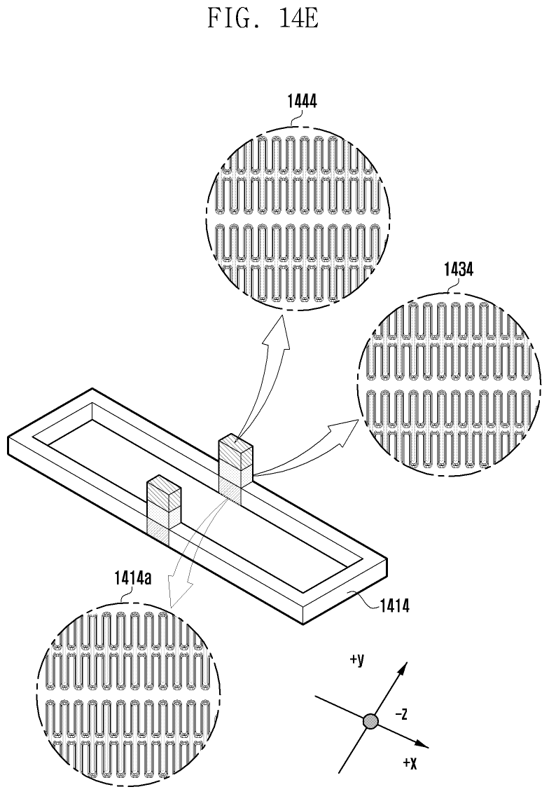

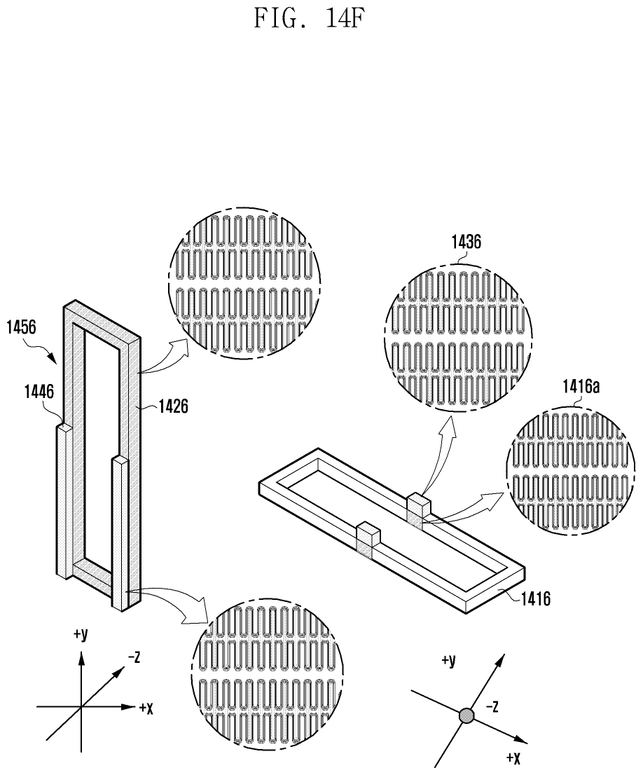

FIGS. 14A, 14B, 14C, 14D, 14E, and 14F illustrate arrangement structures of additional wires according to various embodiments of the disclosure.

FIGS. 14A, 14B, and 14C illustrate an embodiment in which additional wires are arranged in additional layers of the first plate area and the second plate area, and FIGS. 14D, 14E, and 14F illustrate an embodiment in which additional wires following winding paths are arranged in additional layers of a pattern area between the first plate area and the second plate area.

According to an embodiment of the disclosure, a digitizer plate (e.g., the digitizer plate 610 in FIG. 6) may include a first layer (e.g., the first layer 910 in FIG. 9) on which X-channel wires are provided, a second layer (e.g., the second layer 920 in FIG. 9) on which Y-channel wires may be provided, and at least one additional layer disposed between the first layer and the second layer, in which the at least one additional layer may include a first additional layer (e.g., the first additional layer 931 in FIG. 9) and a second additional layer (e.g., the second additional layer 932 in FIG. 9).

According to an embodiment of the disclosure, additional wires electrically connected to the wires of the digitizer may be provided on at least one additional layer of the first plate area and the second plate area of the digitizer plate. The additional wires may be connected in parallel to at least some of the X-channel wires provided on the first layer and/or the Y-channel wires provided on the second layer, and as a result, the resistance of the X-channel wires and/or the Y-channel wires can be reduced. According to an embodiment of the disclosure, the additional wires provided on the first additional layer or the second additional layer may be connected to the wires formed provided on the first layer or the second layer through via through (or via holes).

According to an embodiment of the disclosure, the additional wires may be arranged in an area where the X-channel wires and/or the Y-channel wires are not arranged in at least one additional layer. For example, as described with reference to FIGS. 13C and 13D, at least some of the X-channel wires and/or the Y-channel wires may be arranged at an edge top area and an edge bottom area in the first plate area and the second plate area, and may be arranged on the first additional layer and/or the second additional layer in an area adjacent to a connector to a digitizer driving IC. In this way, the additional wires may be arranged in an area where the X-channel wires and/or the Y-channel wires are not arranged to be connected to the wires on the first layer and/or the second layer.

According to an embodiment of the disclosure, the additional wires may be connected to at least one of an X-channel or a Y-channel used as a driving channel of the digitizer. The digitizer may include a driving channel configured to output a driving signal in response to a signal from the digitizer driving IC and a reception channel configured to receive an electrical signal in response to a touch input using a touch pen (or stylus), and at least one of the X-channel or the Y-channel may be used as the driving channel, and the X-channel and the Y-channel may be used as reception channels. For example, when the X-channel is used as the driving channel of the digitizer, additional wires arranged in an additional layer may be connected to the X-channel wires of the first layer. Alternatively, when the Y-channel is used as the driving channel of the digitizer, additional wires arranged in an additional layer may be connected to the Y-channel wires of the second layer. Alternatively, when the X-channel and the Y-channel are used as driving channels of the digitizer, additional wires arranged in the first additional layer may be connected to the X-channel wires on the first layer, and additional wires arranged on the second additional layer may be connected to the Y-channel wires on the second layer.

Referring to FIG. 14A, an arrangement 1451 of additional wires 1431 and 1441 may be provided in parallel to at least some of Y-channel wires 1421 on the first additional layer and the second additional layer. For example, Y-channel wires may be arranged in the form of straight lines on the second layers of the first plate area and the second plate area, and the additional wires 1431 on the first additional layer and the additional wires 1441 on the second additional layer may be arranged as straight wires in the +z axis direction of the second layer. The additional wires 1431 and 1441 may be connected in parallel to the Y-channel wires of the second layer through via holes. For example, the electronic device may use a Y-channel as a driving channel of the digitizer, and the additional wires 1431 and 1441 may be arranged in an area where the X-channel wires and/or the Y-channel wires are not arranged on the first additional layer and the second additional layer. Accordingly, the thickness of the Y channel wire 1421 used as the driving channel increases, which may have the effect of reducing resistance.

Referring to FIG. 14B, additional wires 1433 and 1443 may be provided in parallel to at least some of the X-channel wires 1413 on the first additional layer and the second additional layer. For example, the X-channel wires 1413 may be arranged in the form of straight lines on the first layers of the first plate area and the second plate area, and the additional wires 1433 on the first additional layer and the additional wires 1443 on the second additional layer may be arranged as straight wires in the −z axis direction of the first layer. The additional wires 1433 and 1443 may be connected in parallel to the X-channel wires 1413 of the first layer through via holes. For example, the electronic device may use an X-channel as a driving channel of the digitizer, and the additional wires 1433 and 1443 may be arranged in an area 1413a where the X-channel wires and/or the Y-channel wires are not arranged on the first additional layer and the second additional layer. For example, on the first layer of the pattern area between the first plate area and the second plate area, wires may be provided through a winding path on the support shafts (or spokes), and due to lack of an arrangement space, X-channel wires may also be provided on the first additional layer and the second additional layer. Accordingly, additional wires may not be provided in the pattern area 1453 of the first additional layer and the second additional layer where the X-channel wires are provided. As described above, since the additional wires 1433 and 1443 are connected in parallel to the X-channel wires 1413, the thickness of a X-channel wire 1412 used as a driving channel may increase, which may have the effect of reducing resistance.

Referring to FIG. 14C, the additional wires 1455 may include first additional wires 1435 provided in parallel to the X-channel wires 1415 of the first layer on the first additional layer, and second additional wires 1445 provided in parallel to the Y-channel wires 1425 of the second layer on the second additional layer. For example, the electronic device may use an X-channel and a Y-channel as driving channels of the digitizer, in which the first additional wires 1435 may be arranged in an area where the X-channel wires and/or the Y-channel wires are not arranged on the first additional layer, and the second additional wires 1445 may be arranged in an area where the X-channel wires and/or the Y-channel wires are not arranged on the second additional layer. According to an embodiment of the disclosure, on the first layer 1415a of the pattern area between the first plate area and the second plate area, wires may be provided through a winding path on the support shafts (or spokes), and due to lack of an arrangement space, X-channel wires may also be provided on the first additional layer. Accordingly, additional wires may not be provided in the pattern area 1456 of the first additional layer where the X-channel wires are provided.

According to an embodiment of the disclosure, a digitizer plate (or support plate) may include wires to detect an electronic pen (or stylus), and among the wires, at least two wires arranged on different layers of the folding area of the digitizer plate may extend in parallel in the x-axis direction via the folding area. For example, additional wires may be arranged on the first additional layer and the second additional layer between the first layer and the second layer in the folding area, and the additional wires may be provided on a winding path provided on the support shafts (or spokes) of the pattern area.

According to an embodiment of the disclosure, additional wires provided on different layers may be connected to each other through via holes, and may extend to the first plate area and the second plate area as a single wire.

FIG. 14D illustrates wires 1452 provided on the second layer, the first additional layer, and the second additional layer of the pattern area between the first plate area and the second plate area. In the pattern area, wires and additional wires of the digitizer may be provided along a winding path provided on support shafts (or spokes) in the second layer, the first additional layer, and the second additional layer.

Referring to FIG. 14D, Y-channel wires may be provided on the second layer of the pattern area. The additional wires 1442 and 1432 may be arranged on the first additional layer and the second additional layer, and may be arranged in areas where the X-channel wires and/or the Y-channel wires are not arranged in the first additional layer and the second additional layer. The additional wires 1442 and 1432 may be provided along a winding path on the support shafts (or spokes) in the first additional layer and the second additional layer. According to an embodiment of the disclosure, the electronic device may use a Y-channel as the driving channel of the digitizer. In this case, as illustrated in FIG. 14D, additional wires 1442 and 1443 provided on the first additional layer and the second additional layer in the pattern area may be connected to the Y-channel wires on the second layer through via holes. FIG. 14E illustrates wires provided on the first layers of the first plate area and the second plate area, and the first layer, the first additional layer, and the second additional layer of the pattern area.

Referring to FIG. 14E, X-channel wires 1414 forming a loop elongated in the x-axis direction may be provided on the first layer. The X-channel wires may be provided along a winding path on the first layer of the pattern area to extend to the first plate area and the second plate area. According to an embodiment of the disclosure, the additional wires 1414a, 1434, and 1444 may be provided on the first additional layer and the second additional layer of the pattern area. The additional wires may be provided along a winding path on the first additional layer and the second additional layer to correspond to the X-channel wires provided along a winding path on the first layer.

According to an embodiment of the disclosure, the electronic device may use an X-channel as the driving channel of the digitizer. In this case, as illustrated in FIG. 14E, additional wires 1444 and 1434 provided on the first additional layer and the second additional layer in the pattern area may be connected to the X-channel wires on the first layer through via holes.

According to an embodiment of the disclosure, in the pattern area, the additional wires 1434 and 1444 may be provided in an area where the X-channel wires and/or the Y-channel wires are not provided in the first additional layer and the second additional layer.

According to an embodiment of the disclosure, the additional wires 1434 arranged on the first additional layer and the additional wires 1444 arranged on the second additional layer in the pattern area may be connected to each other through via holes. The additional wires may be connected to each other through via holes to electrically extend to the first plate area and the second plate area as a single wire.

According to an embodiment of the disclosure, at least one of the X-channel wires extending to the first and second areas of the digitizer plate may be connected to the wires arranged on the first additional layer and the second additional layer of the pattern area through via holes.

FIG. 14F illustrates a pattern area, additional wires 1456 connected to X-channel wires are provided on the first additional layer and additional wires connected to Y-channel wires are provided on the second additional layer.

Referring to FIG. 14F, the additional wires 1436 and 1446 may include first additional wires 1436 provided on the first additional layer and connected to the X-channel wires 1416 of the first layer, and second additional wires 1446 provided on the second additional layer and connected to the Y-channel wires 1426 of the second layer. For example, on the first layer of the pattern area, X-channel wires 1416a may be provided along a winding path, and additional wires 1436 provided on the first additional layer may be connected to the X-channel wires 1416a through via holes. On the second layer of the pattern area, Y-channel wires 1426 may be provided along a winding path, and additional wires 1446 provided on the second additional layer may be connected to the Y-channel wires 1416a through via holes.

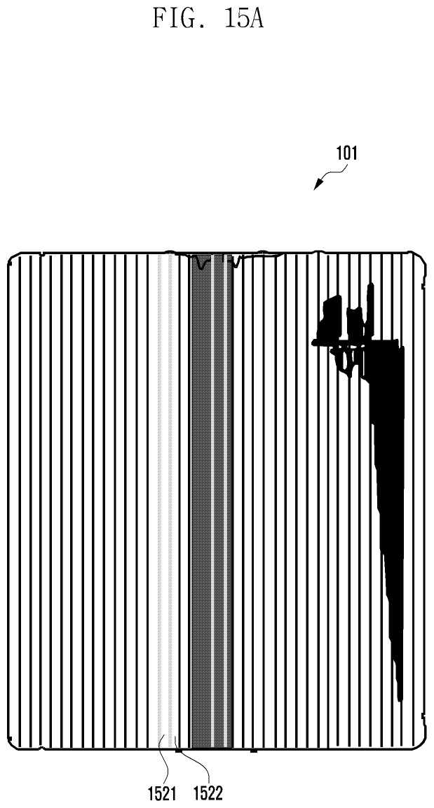

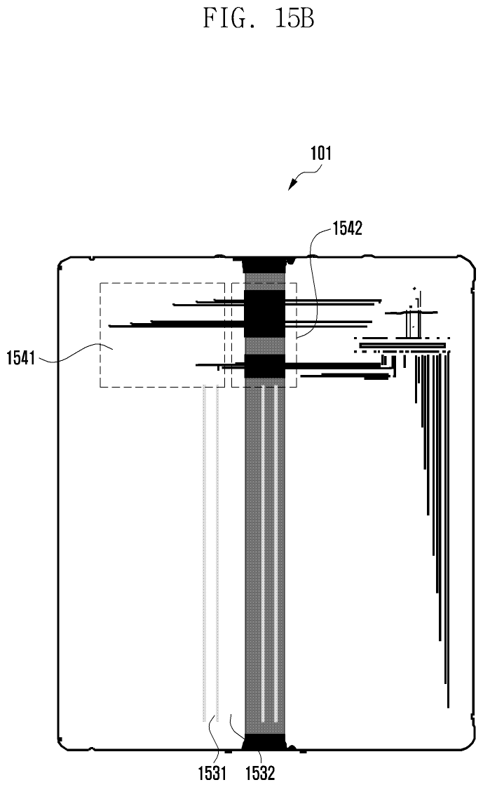

FIGS. 15A and 15B illustrate arranged positions of additional wires according to various embodiments of the disclosure.

According to an embodiment of the disclosure, additional wires connected to the X-channel wires of the first layer or the Y-channel wires of the second layer may be arranged in an area where the X-channel wires and/or the Y-channel wires are not arranged on at least one additional layer.

FIG. 15A illustrates the positions of wires of Channel Y08 provided in the second layer. Referring to FIG. 15A, Channel Y08 may include a large rectangular first loop 1521 formed across the first plate area and the pattern area on the second layer and a second loop 1522 formed across the first plate area and the pattern area and provided in the first loop 1521. The individual loops 1521 and 1522 may be electrically connected to each other, and in a partial section, the wires of Channel Y08 may be arranged on the second additional layer.

FIG. 15B illustrates the positions 1541 and 1542 of additional wires provided on the second additional layer.

According to an embodiment of the disclosure, additional wires connected to the wires of the digitizer may be arranged in an area where the X-channel wires and/or the Y-channel wires are not arranged on the first additional layer and the second additional layer.

Referring to FIG. 15B, additional wires 1531 and 1532 connected to Channel Y08 may be arranged in an area where the Y-channel wires are not arranged in the second additional layer. For example, on the second additional layer, Y-channel wires may be provided in a top edge area and a bottom edge area of the pattern area, and an area adjacent to the connector. The additional wires 1531 and 1532 connected to Channel Y08 may be provided in parallel to two loops on the second additional layer where Channel Y08 is provided, and may not be provided in the area where the Y-channel wires are arranged on the second additional layer.

According to another embodiment of the disclosure, the additional wires may be provided at positions of the first additional layer and/or the second additional layer corresponding to the positions of the Y-channel wires in the pattern area. For example, in the first loop 1521 and the second loop 1522, the additional wires may be arranged to correspond to the positions where the Y-channel wires are provided.

According to various embodiments of the disclosure, the pattern area (or a lattice structure) and the additional wires connected in parallel in order to increase the thicknesses of the wires passing through the pattern area and the wires of the digitizer may also be included in a slidable-type electronic device.

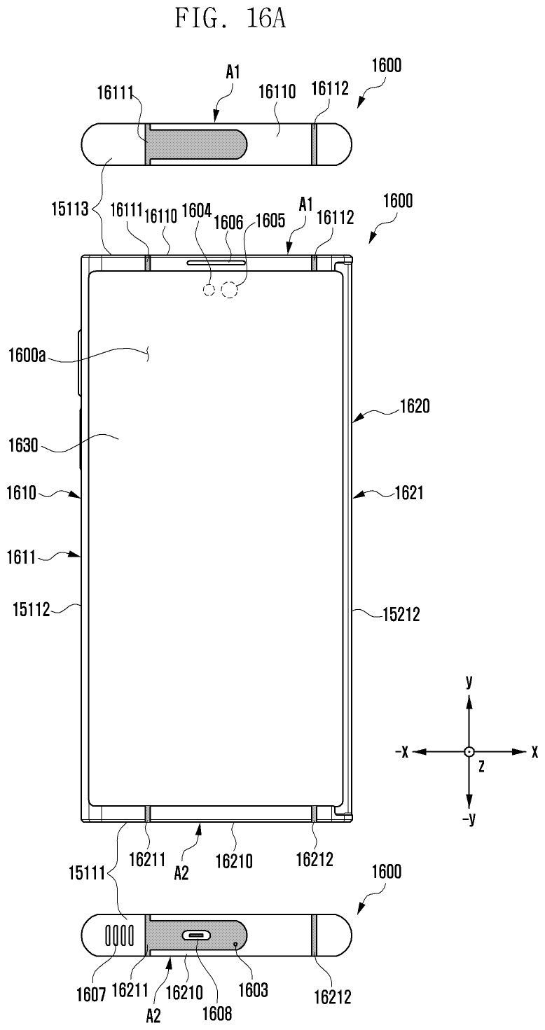

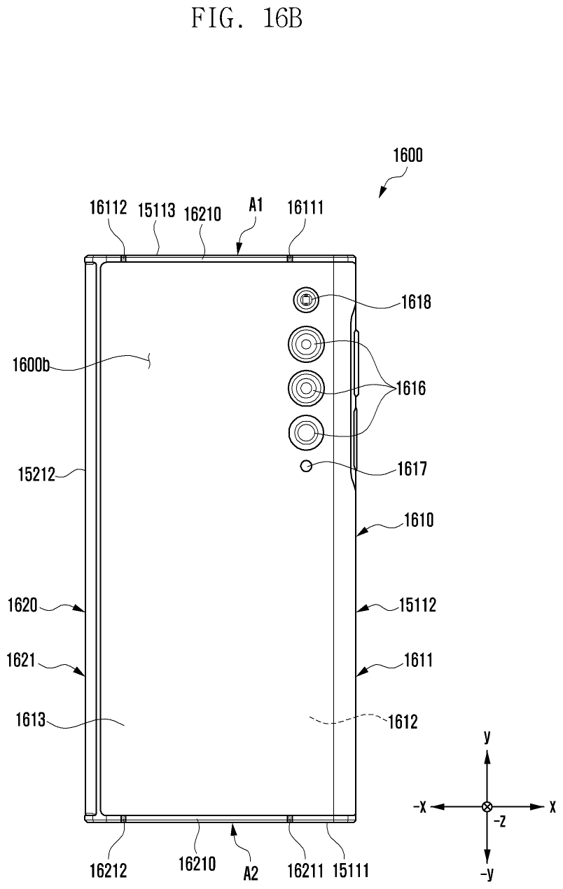

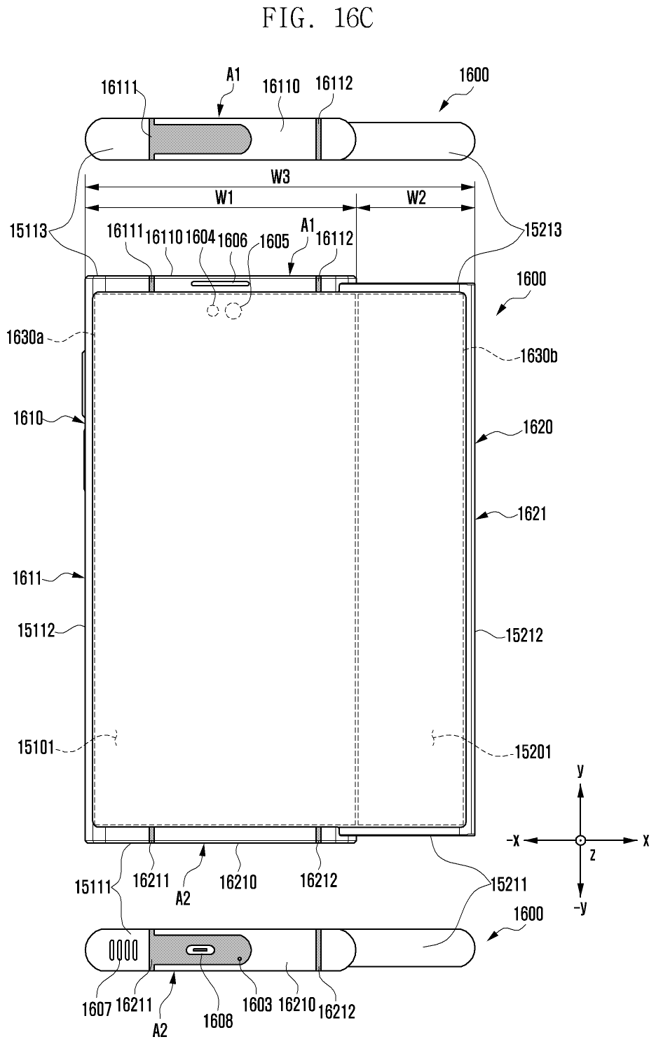

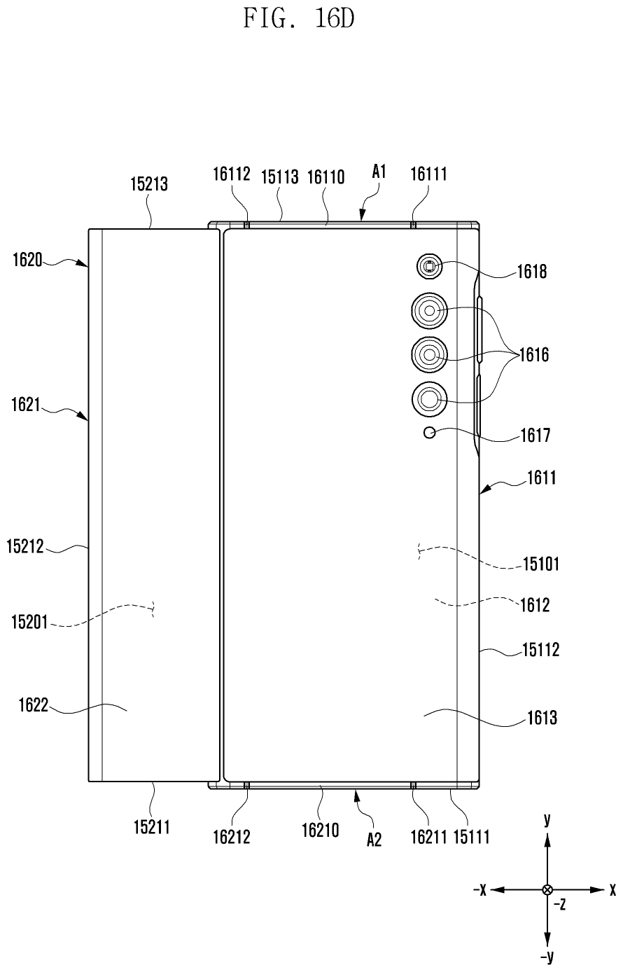

Hereinafter, with reference to FIGS. 16A, 16B, 16C, and 16D, the configuration of an electronic device including a display and a housing structure that is horizontally expandable (i.e., expandable left or right with reference to the vertical direction of the electronic device (or a portrait type)) will be described.

FIGS. 16A and 16B are front and rear views of a horizontally expandable electronic device in a slide-in state according to various embodiments of the disclosure. FIGS. 16C and 16D are front and rear views of the electronic device in a slide-out state according to various embodiments of the disclosure.

Referring to FIGS. 16A to 16D, an electronic device 1600 may include a first housing part 1610 (or a fixing part or a base housing), a second housing part 1620 (e.g., a movable part or a slide housing) coupled to be movable from the first housing part 1610 in a predetermined direction (e.g., the x-axis direction) within a predetermined distance, and a flexible display 1630 disposed to be supported by at least a portion of the first housing part 1610 and the second housing part 1620. The flexible display 1630 may include an expandable display or a stretchable display. As the second housing part 1620 moves from the first housing part 1610, the flexible display 1630, the size of the area visible of the flexible display 1630 on the front surface may change (e.g., expand or contract). The flexible display 1630 may include at least some of the components and/or functions of the display module 160 illustrated in FIG. 1.

According to an embodiment of the disclosure, when at least a portion of the second housing part 1620 is accommodated in a first space 15101 of the first housing part 1610, the electronic device 1600 may be switched into the slide-in state. The electronic device 1600 may include a bendable member or a bendable support member (e.g., an articulated hinge module or a multi-bar assembly), which at least partially forms the same plane with at least a portion of the first housing part 1610 in the slide-out state, and is at least partially accommodated in a second space 15201 in the second housing part 1620 in the slide-in state.

According to an embodiment of the disclosure, in the slide-in state, at least a portion of the flexible display 1630 may be accommodated in the inner space 15201 of the second housing part 1620 while being supported by the bendable member, whereby the portion of the flexible display may be disposed to be invisible from the outside. In the slide-out state, at least a portion of the flexible display 1630 may be disposed to be visible from the outside while being supported by the bendable member that at least partially forms the same plane with the first housing part 1610.

According to various embodiments of the disclosure, the electronic device 1600 may include a front surface 1600a (e.g., a first surface), a rear surface 1600b (e.g., a second surface) facing away from the front surface 1600a, and a side surface (not illustrated) surrounding the space between the front surface 1600a and the rear surface 1600b. For example, in the electronic device 1600, the first housing part 1610 may include a first side surface member 1611, and the second housing part 1620 may include a second side surface member 1621.

According to an embodiment of the disclosure, the first side surface member 1611 may include a first side surface 15111 having a first length along a first direction (e.g., the x-axis direction), a second side surface 15112 extending from the first side surface 15111 along a direction substantially perpendicular to the first side surface 15111 (e.g., the y-axis direction) and having a second length larger than the first length, and a third side surface 15113 extending from the second side surface 15112 to be substantially parallel to the first side surface 15111 and having the first length. The first side surface member 1611 may be at least partially made of a conductive member (e.g., metal). At least a portion of the first side surface member 1611 may include a first support member 1612 extending to at least a portion of the first space 15101 of the first housing part 1610. According to an embodiment of the disclosure, a first side surface member 16110 and/or a second side surface member 16210 may include at least one conductive portion 16111 and/or 16112 electrically split from each other through at least one split portion 16211 and/or 16212.

According to an embodiment of the disclosure, the second side surface member 1621 may include a fourth side surface 15211 at least partially corresponding to the first surface 15111 and having a third length, a fifth side surface 15212 extending from the fourth side surface 15211 in a direction substantially parallel to the second side surface 15112 and having a fourth length larger than the third length, and a sixth side surface 15213 extending from the fifth side surface 15212 to correspond to the third side surface 15113 and having the third length. The second side surface member 1621 may be at least partially made of a conductive member (e.g., metal). At least a portion of the second side surface member 1621 may include a second support member 1622 extending to at least a portion of the second space 15201 of the second housing part 1620.

According to an embodiment of the disclosure, the first and fourth side surfaces 15111 and 15211 and the third and sixth side surfaces 15211 and 15213 may be slidably coupled to each other. When the electronic device 1600 is in the slide-in state, the fourth side surface 15211 may be disposed to be substantially invisible from the outside by overlapping the first side surface 15211. When the electronic device 1600 is in the slide-in state, the sixth side surface 15213 may be disposed to be substantially invisible from the outside by overlapping the third side surface 15213. In some embodiments of the disclosure, when the electronic device 1600 is in the slide-in state, the fourth side surface 15211 and the sixth side surface 15213 may be disposed to be at least partially visible from the outside.

According to an embodiment of the disclosure, when the electronic device 1600 is in the slide-in state, the second support member 1622 may be disposed to be substantially invisible from the outside by overlapping the first support member 1612. In some embodiments of the disclosure, in the slide-in state, a portion of the second support member 1622 may be disposed to be invisible from the outside by overlapping the first support member 1612, and the remaining portion of the second support member 1622 may be disposed to be visible from the outside.

According to an embodiment of the disclosure, the electronic device 1600 may include a rear surface cover 1613 disposed on at least a portion of the first housing part 1610. The rear surface cover 1613 may be disposed on the rear surface 1600b of the electronic device 1600 through at least a portion of the first support member 1612. In some embodiments of the disclosure, the rear surface cover 1613 may be integrated with the first side surface member 1611. The rear surface cover 1613 may be made of polymer, coated or colored glass, ceramic, metal (e.g., aluminum, stainless steel (STS), or magnesium), or a combination of at least two of these materials. In some embodiments of the disclosure, the rear surface cover 1613 may extend to at least a portion of the first side surface member 1611. At least a portion of the first support member 1612 may be replaced with the rear surface cover 1613. The electronic device 1600 may include another rear surface cover (e.g., a second rear surface cover) disposed in at least a portion of the second support member 1622 in the second housing part 1620 or replaced with at least a portion of the second support member 1622.

According to an embodiment of the disclosure, the electronic device 1600 may include a flexible display 1630 (e.g., the expandable display) disposed to be supported by at least a portion of the first housing part 1610 and at least a portion of the second housing part 1620. The flexible display 1630 may include a first portion 1630a (e.g., a first display) that is always visible from the outside in the slide-in or slide-out state, and a second portion 1630b (e.g., a second display) that extends from the first portion 1630a and expands in a predetermined direction (e.g., the x-axis direction) together with the second housing part 1620 in the slide-out state. The first portion 1630a of the flexible display 1630 may provide a first display area, and the second portion 1630b may provide a second display area. The first portion 1630a of the flexible display 1630 may provide a flat surface, and in the slide-in state, the second portion 1630b may provide a bendable portion at least partially accommodated in the second space 15201 of the second housing part 1620 to be at least partially invisible from the outside. The first portion 1630a may be disposed to be supported by the first housing part 1610, and the second portion 1630b may be disposed to be at least partially supported by the bendable member. As the second housing part 1620 is moved out along a predetermined direction (e.g., in the x-axis direction), the second portion 1630b of the flexible display 1630 may extend from the first portion 1630a while being supported by the bendable member, and may be disposed to be visible from the outside while forming substantially the same plane with the first portion 1630a. As the second housing part 1620 is moved into the first housing part 1610 along a predetermined direction (e.g., the −x-axis direction), the second portion 1630b of the flexible display 1630 may be accommodated in the second space 16201 of the second housing part 1620 and disposed to be invisible from the outside. In the electronic device 1600, as the second housing part 1620 is slid (e.g., slid out) from the first housing part 1610 in a predetermined direction (e.g., the x-axis direction), the display area of the flexible display 1630 can be expanded.

In an embodiment of the disclosure, in the slide-in state, the electronic device 1600 may display at least one application by using the first portion 1630a (e.g., the first display area) of the flexible display 1630. In another embodiment of the disclosure, in the state in which the second housing part 1620 is slid out from the first housing part 1610, the electronic device 1600 may display at least one application by using the first portion 1630a (e.g., the first display area) and the second portion 1630b (e.g., the second display area). In various embodiments of the disclosure, in the slide-out state, the flexible display 1630 may display a first application A by using the first portion 1630a and display a second application B by using the second portion 1630b.

In an embodiment of the disclosure, referring to FIG. 16C, the size of the first portion 1630a (e.g., the first display area) of the flexible display 1630 is illustrated as being larger than the size of the second portion 1630b (e.g., the second display area), but the sizes of the first portion 1630a and the second portion 1630b may be substantially the same, or the size of the second portion 1630b may be larger than the size of the first portion 1630a. The sizes of the first portion 1630a and the second portion 1630b of the flexible display 1630 may be the same or different from each other.

According to an embodiment of the disclosure, the first housing part 1610 and the second housing part 1620 may be operated with respect to each other in a sliding manner such that the entire width is variable. Referring to FIG. 16C, the electronic device 1600 may be configured to have a first width W1 from the second side surface 15112 to the fifth side surface 15212 in the slide-in state. The electronic device 1600 may be configured to have a third width W3 larger than the first width W1 by moving at least a portion of the bendable member accommodated in the second space 15201 of the second housing part 1620 to have an additional second width W2 in the slide-out state. For example, in the slide-in state, the flexible display 1630 may have a display area substantially corresponding to the first width W1, and in the slide-out state, the flexible display 230 may have an expanded display area substantially corresponding to the third width W3. In an embodiment of the disclosure, FIG. 16C illustrates that the second width W2 is smaller than the first width W1, but the first width W1 and the second width W2 may be configured to be substantially the same. In an embodiment of the disclosure, the first portion 1630a and the second portion 1630b of the flexible display 1630 may be configured to have a display screen of substantially the same size.

According to an embodiment of the disclosure, the electronic device 1600 may include a driver (or actuator) (not illustrated) configured to move the second housing part 1620 from the first housing part 1610. For example, the driver may include a rotary motor structure, and when a user presses a specific button and/or moves a portion of the second housing part 1620, the motor may be activated to provide a driving force for slide movement of the second housing part 1620.

According to an embodiment of the disclosure, the electronic device 1600 may include at least one of an input module (e.g., a microphone 1603) disposed in the first space 15101 of the first housing part 1610, a sound output module (e.g., a call receiver 1606 or a speaker 1607), sensor modules 1604 and 1617, camera modules (e.g., the first camera module 1605 and the second camera module 1616), a connector port 1608, a key input device (not illustrated), or an indicator (not illustrated). The electronic device 1600 may be configured such that at least one of the above-mentioned components is omitted or other components are additionally included. As another embodiment of the disclosure, at least one of the above-described components may be disposed in the second space 15201 of the second housing part 1620.

According to various embodiments of the disclosure, the input module may include an embodiment related to the input module 150 in FIG. 1. The sound output module may include an embodiment related to the sound output module 155 in FIG. 1. The sensor modules 1604 and 1617 may include an embodiment related to the sensor module 176 in FIG. 1. The camera module may include an embodiment related to the camera module 180 in FIG. 1.

According to an embodiment of the disclosure, the input module (e.g., input module 150 in FIG. 1) may include a microphone 1603. In some embodiments of the disclosure, the input module (e.g., the microphone 1603) may include multiple microphones arranged to detect the direction of sound. The sound output module may include, for example, a call receiver 1606 and a speaker 1607. In the slide-out state, the speaker 1607 may face the outside through at least one speaker hole provided in the first housing part 1610. In the slide-out state, the connector port 1608 may face the outside through a connector port hole provided in the first housing part 1610. The call receiver 1606 may include a speaker that is operated without a separate speaker hole (e.g., a piezo speaker).

According to various embodiments of the disclosure, the sensor modules 1604 and 1617 (e.g., the sensor module 176 in FIG. 1) may generate an electrical signal or a data value corresponding to the internal operating state or the external environmental state of the electronic device 1600. The sensor modules 1604 and 1617 may include, for example, a first sensor module 1604 (e.g., a proximity sensor or an illuminance sensor) disposed on the front surface 1600a of the electronic device 1600 and/or a second sensor module 1617 (e.g., a heart rate monitoring (HRM) sensor) disposed on the rear surface 1600b. The first sensor module 1604 may be disposed on the rear surface of the flexible display 1630 (e.g., in the −z-axis direction) in the front surface 1600a of the electronic device 1600. The first sensor module 1604 and/or the second sensor module 1617 may include at least one of a proximity sensor, an illuminance sensor, a time-of-flight (TOF) sensor, an ultrasonic sensor, a fingerprint recognition sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, or a humidity sensor.

According to an embodiment of the disclosure, the camera modules (e.g., the camera module 180 in FIG. 1) may include a first camera module 1605 disposed on the front surface 1600a of the electronic device 1600 and a second camera module 1616 disposed on the rear surface 1600b. The electronic device 1600 may include a flash 1618 located near the second camera module 1616. The camera modules 1605 and 1616 may include one or more lenses, an image sensor, and/or an image signal processor. The first camera module 1605 may be disposed on the rear surface of the flexible display 1630 (e.g., in the −z-axis direction) and configured to photograph a subject through a portion of the active area of the flexible display 1630. The flash 1618 may include, for example, a light-emitting diode or a xenon lamp.

According to an embodiment of the disclosure, the first camera module 1605 among the camera modules and some sensor modules 1604 among the sensor modules 1604 and 1617 may be disposed to detect the external environment through the flexible display 1630.

According to an embodiment of the disclosure, the electronic device 1600 may include one or more antennas A1 and A2 electrically connected to a wireless communication circuit (e.g., the wireless communication module 192 in FIG. 1) disposed in the first space 15101 of the first housing part 1610. The one or more antennas A1 and A2 may include a first antenna A1 and a second antenna A2 disposed in an upper area and a lower area of the electronic device 1600.

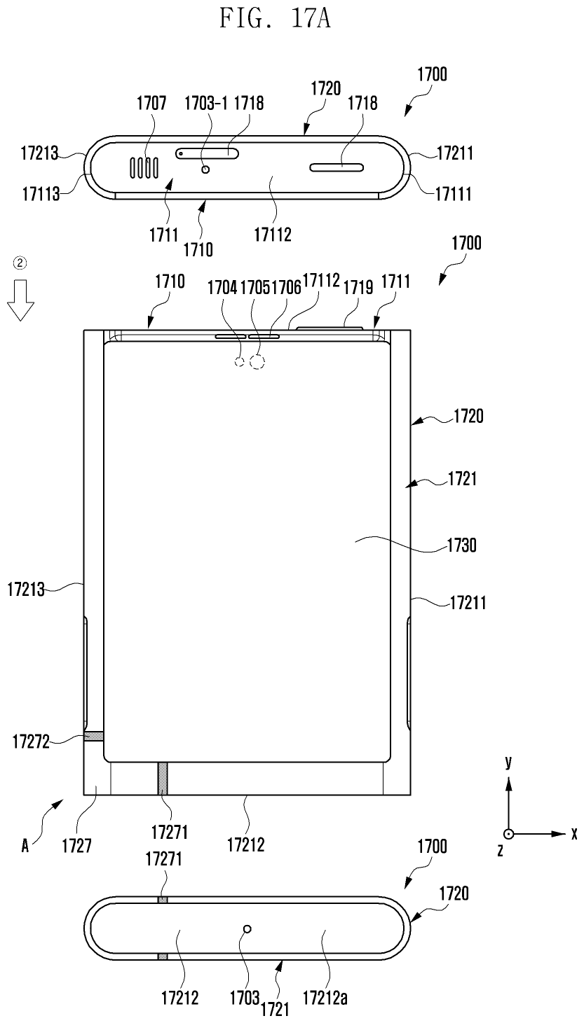

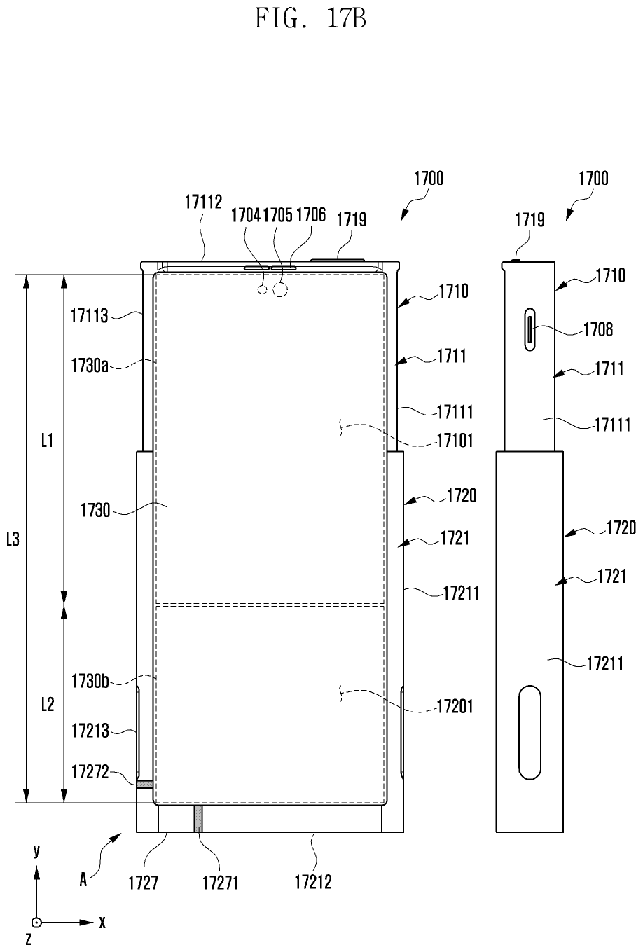

Hereinafter, with reference to FIGS. 17A and 17B, the configuration of an electronic device including a display that is vertically expandable (i.e., expandable up or down with reference to the vertical direction of the electronic device (or a portrait type)) will be described.

FIG. 17A is a view illustrating a vertically expandable electronic device in the slide-in state according to an embodiment of the disclosure. FIG. 17B is a front view of the vertically expandable electronic device in the slide-out state according to an embodiment of the disclosure.

Referring to FIGS. 17A and 17B, an electronic device 1700 may include a first housing part 1710, a second housing part 1720 coupled to the first housing part 1710 to be slidable in a predetermined direction (e.g., direction \textcircled{1} or \textcircled{2}) (e.g., the y-axis direction), and a flexible display 1730 disposed to be supported by at least a portion of the first housing part 1710 and at least a portion of the second housing part 1720. The flexible display 1730 may include an expandable display or a stretchable display. The flexible display 1730 may include at least some of the components and/or functions of the display module 160 illustrated in FIG. 1.

According to an embodiment of the disclosure, in the electronic device 1700, with reference to the second housing part 1720 held by a user, the first housing part 1710 may be disposed to be slid out in a first direction (direction \textcircled{1}) or slid in in a second direction (direction \textcircled{2}) opposite to the first direction (direction \textcircled{1}). According to an embodiment of the disclosure, at least a portion of the first housing part 1710 including a first space 17101 may be switched into the slide-in state by being accommodated in the second space 17201 of the second housing part 1720.

According to an embodiment of the disclosure, the electronic device 1700 may include a bendable member or a bendable support member, which at least partially forms the same plane with at least a portion of the first housing part 1710 in the slide-out state, and is at least partially accommodated in the second space 17201 in the second housing part 1720 in the slide-in state.

According to an embodiment of the disclosure, in the slide-in state, at least a portion of the flexible display 1730 may be accommodated in the inner space 17201 of the second housing part 1720 while being supported by the bendable member, whereby the portion of the flexible display may be disposed to be invisible from the outside. According to an embodiment of the disclosure, in the slide-out state, at least a portion of the flexible display 1730 may be disposed to be visible from the outside while being supported by the bendable member that at least partially forms the same plane with the first housing part 1710.

According to an embodiment of the disclosure, the electronic device 1700 may include a first housing part 1710 including a first side surface member 1711 and a second housing part 1720 including a second side surface member 1721. According to an embodiment of the disclosure, the first side surface member 1711 may include a first side surface 17111 having a first length along a first direction (e.g., the y-axis direction), a second side surface 17112 extending from the first side surface 17111 along a direction substantially perpendicular to the first side surface 17111 (e.g., the x-axis direction) and having a second length smaller than the first length, and a third side surface 17113 extending from the second side surface 17112 to be substantially parallel to the first side surface 2111 and having the first length. According to an embodiment of the disclosure, at least a portion of the first side surface member 1711 may be made of a conductive material (e.g., metal). In some embodiments of the disclosure, the first side surface member 1711 may be configured by a combination of a conductive material and a non-conductive material (e.g., polymer).

According to an embodiment of the disclosure, the first housing part 1710 may include a first support member 1712 extending from at least a portion of the first side surface member 1711 to at least a portion of the first space 17101. According to an embodiment of the disclosure, the first support member 1712 may be configured integrally with the first side surface member 1711. In some embodiments of the disclosure, the first support member 1712 may be configured separately from the first side surface member 1711 and structurally coupled to the first side surface member 1711.

According to an embodiment of the disclosure, the second side surface member 1721 may include a fourth side surface 17211 at least partially corresponding to the first surface 17111 and having a third length, a fifth side surface 17212, 17212a extending from the fourth side surface 17211 in a direction substantially parallel to the second side surface 17112 and having a fourth length smaller than the third length, and a sixth side surface 17213 extending from the fifth side surface 17212, 17212a to correspond to the third side surface 17113 and having the third length. According to an embodiment of the disclosure, at least a portion of the second side surface member 1721 may be made of a conductive material (e.g., metal). In some embodiments of the disclosure, the second side surface member 1721 may be configured by a combination of a conductive material and a non-conductive material (e.g., polymer). According to an embodiment of the disclosure, at least a portion of the second side surface member 1721 may include a second support member 1722 extending to at least a portion of the second space 17201 of the second housing part 1720. According to an embodiment of the disclosure, the second support member 1722 may be configured integrally with the second side surface member 1721. In some embodiments of the disclosure, the second support member 1722 may be configured separately from the second side surface member 1721 and structurally coupled to the second side surface member 1721.

According to an embodiment of the disclosure, the first side surface 17111 and the fourth side surface 17211 may be slidably coupled to each other. According to an embodiment of the disclosure, the third side surface 17113 and the sixth side surface 17213 (near an edge 1727 with split portions 17271 and 17272) may be slidably coupled to each other. According to an embodiment of the disclosure, in the slide-in state, the first side surface 17111 may be disposed to be substantially invisible from the outside by overlapping the fourth side surface 17211. According to an embodiment of the disclosure, in the slide-in state, the third side surface 17113 may be disposed to be substantially invisible from the outside by overlapping the sixth side surface 17213. In some embodiments of the disclosure, in the slide-in state, the first and third side surfaces 17111 and 17113 may be disposed to be at least partially visible from the outside. According to an embodiment of the disclosure, in the slide-in state, the first support member 1712 may be disposed to be substantially invisible from the outside by overlapping the second support member 1722.

According to an embodiment of the disclosure, the electronic device 1700 may include a first rear surface cover 1713 coupled to the first housing part 1710 on the rear surface thereof. According to an embodiment of the disclosure, the first rear surface cover 1713 may be disposed through at least a portion of the first support member 1712. In some embodiments of the disclosure, the first rear surface cover 1713 may be configured integrally with the first side surface member 1711. According to an embodiment of the disclosure, the first rear surface cover 1713 may be made of a polymer, coated or tinted glass, ceramic, a metal (e.g., aluminum, stainless steel (STS), or magnesium), or a combination of at least two of these materials. In some embodiments of the disclosure, the first rear surface cover 1713 may extend to at least a portion of the first side surface member 1711. In some embodiments of the disclosure, at least a portion of the first support member 1712 may be replaced with the first rear surface cover 1713.

According to an embodiment of the disclosure, the electronic device 1700 may include a second rear surface cover 1723 coupled to the second housing part 1720 on the rear surface thereof. According to an embodiment of the disclosure, the second rear surface cover 1723 may be disposed through at least a portion of the second support member 1722. In some embodiments of the disclosure, the second rear surface cover 1723 may be configured integrally with the second side surface member 1721. According to an embodiment of the disclosure, the second rear surface cover 1723 may be made of a polymer, coated or tinted glass, ceramic, a metal (e.g., aluminum, stainless steel (STS), or magnesium), or a combination of at least two of these materials. In some embodiments of the disclosure, the second rear surface cover 1723 may extend to at least a portion of the second side surface member 1721. In some embodiments of the disclosure, at least a portion of the second support member 1722 may be replaced with the second rear surface cover 1723.

According to an embodiment of the disclosure, the electronic device 1700 may include a flexible display 1730 disposed to be supported by at least a portion of the first housing part 1710 and at least a portion of the second housing part 1720. According to an embodiment of the disclosure, the flexible display 1730 may include a first portion 1730a (e.g., a flat portion) that is always visible from the outside, and a second portion 1730b (e.g., a bendable portion) extending from the first portion 1730a and at least partially accommodated in the second space 17201 of the second housing part 1720 to be to be at least partially invisible from the outside in the slide-in state.

According to an embodiment of the disclosure, the first portion 1730a may be disposed to be supported by the first housing part 1710, and the second portion 1730b may be disposed to be at least partially supported by the bendable member.

According to an embodiment of the disclosure, in the state in which the first housing part 1710 is slid out along the first direction (direction \textcircled{1}), the second portion 1730b of the flexible display 1730 may be disposed to extend from the first portion 1730a while being supported by the bendable member, form substantially the same plane with the first portion 1730a, and be visible from the outside. According to an embodiment of the disclosure, in the state in which the second housing part 1720 is slid in along the second direction (direction \textcircled{2}), the second portion 1730b of the flexible display 1730 may be disposed to be accommodated into the second space 17201 of the second housing part 1720 and be invisible from the outside. Accordingly, in the electronic device 1700, the display area of the flexible display 1730 may be induced to be variable as the first housing part 1710 is moved in a sliding manner from the second housing part 1720 along a predetermined direction (e.g., the y-axis direction).

According to an embodiment of the disclosure, the flexible display 1730 may be variable in length in the first direction (direction \textcircled{1}) depending on the sliding of the first housing part 1710 that is moved with respect to the second housing part 1720. For example, in the slide-in state, the flexible display 1730 may have a first display area corresponding to the first length L1 (e.g., an area corresponding to the first portion 1730a). According to an embodiment of the disclosure, in the slide-out state, depending on the sliding of the first housing part 1710 further moved by the second length L2 with respect to the second housing part 1720, the flexible display 1730 may be expanded to have a third display area (e.g., an area including the first portion 1730a and the second portion 1730b), which corresponds to the third length L3 larger than the first length L1 and is larger than the first display area.

According to an embodiment of the disclosure, the electronic device 1700 may include at least one of an input module (e.g., a microphone 1703-1) disposed in the first space 17101 of the first housing part 1710, a sound output device (e.g., a phone call receiver 1706 or a speaker 1707), sensor modules 1704 and 217, a camera module (e.g., the first camera module 1705 or the second camera module on the rear surface), a connector port 1708, a key input device 1719, or an indicator (not illustrated). According to an embodiment of the disclosure, the electronic device 1700 may include another input device (e.g., the microphone 1703) disposed on the second housing part.

According to an embodiment of the disclosure, the slide-in and slide-out operations of the electronic device 1700 may be automatically performed. For example, the slide-in and slide-out operations of the electronic device 1700 may be performed through the gearing operation between a drive motor including a pinion gear 1761 disposed in the first space 17101 of the first housing part 1710 and a rack gear disposed in the second space 17201 of the second housing part 1720 and meshed with the pinion gear 1761. For example, when detecting a triggering operation of switching from the slide-in state to the slide-out state or from the slide-out state to the slide-in state, the processor (e.g., the processor 120 in FIG. 1) of the electronic device 1700 may operate the driver (e.g., the driving motor) disposed inside the electronic device 1700. According to an embodiment of the disclosure, the triggering operation may include selecting (e.g., touching) an object displayed on the flexible display 1730 or operating a physical button (e.g., a key button) included in the electronic device 1700.

According to various embodiments of the disclosure, a pattern area (or lattice structure), wires passing through the pattern area, and additional wires connected in parallel to expand the thickness of the wires of a digitizer may also be included in the slidable-type electronic device illustrated in FIGS. 16A to 16D or FIGS. 17A and 17B.

For example, a portion of the housing of a slidable-type electronic device may also have a bending area, and a pattern area (or recess structure) including openings may be provided in the bending area. At least some of the wires of the digitizer may be disposed on the support shafts (or spokes) of the pattern area and pass through the pattern area. According to an embodiment of the disclosure, additional wires connected in parallel with the wires of the digitizer may be provided in the pattern area or another area where the wires of the digitizer are not provided. Additional wires may be arranged on a different layer from the wires of the digitizer and connected to the wires of the digitizer through via holes.

An electronic device according to various embodiments of the disclosure may include a first housing, a second housing rotatably connected to the first housing, a display panel disposed across the first housing and the second housing, and a digitizer plate disposed below the display panel and including wires of a digitizer.

According to an embodiment of the disclosure, the digitizer plate may include a first plate area disposed in the first housing, a second plate area disposed in the second housing, and a pattern area provided between the first plate area and the second plate area and including a plurality of openings.

According to an embodiment of the disclosure, the first plate area and the second plate area of the digitizer plate may include a plurality of layers including a first layer and a second layer where the wires of the digitizer are provided, and at least one additional layer, and the at least one additional layer in the first plate area and/or the second plate area may be provided with an additional wire electrically connected to the wires of the digitizer provided on the first layer and/or the second layer.

According to an embodiment of the disclosure, the patterns provided in the pattern area may be configured by the openings provided in a folding area of the support plate, and among the wires of the digitizer, wires provided across the first plate area and the second plate area may extend from the first plate area to the second plate area along a winding path around the openings of the pattern area.

According to an embodiment of the disclosure, some of the wires provided on the first layer may extend to avoid the openings in the pattern area openings, and others may pass through the at least one additional layer of the pattern area.

According to an embodiment of the disclosure, the at least one additional layer may be provided between the first layer and the second layer.

According to an embodiment of the disclosure, the at least one additional layer may include a first additional layer adjacent to the first layer and a second additional layer adjacent to the second layer.

According to an embodiment of the disclosure, the first layer may include X-channel wires of the digitizer, and the second layer may include Y-channel wires of the digitizer.

According to an embodiment of the disclosure, the X-channel wires may form an electrical loop elongated in a horizontal direction of the electronic device, and the Y-channel wires may form an electrical loop elongated in a vertical direction of the electronic device.

According to an embodiment of the disclosure, the additional wire may be connected to the wires of at least one of the X-channel or the Y-channel used as a driving channel of the digitizer.

According to an embodiment of the disclosure, when the X-channel is used as the driving channel of the digitizer, the additional wire disposed in the at least one additional layer may be connected to the wires of the digitizer on the first layer.

According to an embodiment of the disclosure, when the Y channel is used as the driving channel of the digitizer, the additional wire disposed in the at least one additional layer may be connected to the wires of the digitizer on the second layer.

According to an embodiment of the disclosure, when the X-channel and the Y-channel are used as driving channels of the digitizer, an additional wire disposed in the first additional layer may be connected to the wires of the digitizer on the first layer, and an additional wire disposed on the second additional layer may be connected to the wires of the digitizer on the second layer.

According to an embodiment of the disclosure, the additional wire may not be disposed in an area of the at least one additional layer where the wires of the digitizer are disposed.

According to an embodiment of the disclosure, the additional wire disposed in the at least one additional layer may be connected to the wires of the digitizer on the first layer and/or the second layer via a via hole.

According to an embodiment of the disclosure, the additional wire may be connected in parallel to the wires of the digitizer.

According to an embodiment of the disclosure, the electronic device may further include a digitizer driving IC configured to process a signal from the digitizer, and a connector interconnecting the wires of the digitizer and the digitizer driving IC may be disposed in the first housing or the second housing.

An electronic device according to various embodiments of the disclosure may include a first housing, a second housing, and a hinge housing connected to the first housing and the second housing, and a flexible display disposed on the foldable housing and including a display panel and a support plate disposed between the display panel and the foldable housing. The support plate may include a first area corresponding to the first housing, a second area corresponding to the second housing, and a folding area corresponding to the hinge housing, and further include patterns to bend the folding area. The support plate may include wires provided to detect an electronic pen, and among the wires, at least two wires disposed on different layers of the folding area of the support plate may extend in parallel in a first direction via the folding area.

According to an embodiment of the disclosure, the at least two wires may be connected to each other via at least one via and extend to the first area and/or the second area as a single wire.

According to an embodiment of the disclosure, among the wires, the single wire extending to the first area and the second area of the support plate may be connected to at least two wires disposed on different layers of the folding area of the support plate via at least one via.

According to an embodiment of the disclosure, the folding area of the support plate may include a first layer and a second layer where at least two conductive layers are provided, and a glass fiber reinforced polymer (GFRP) layer may be disposed between the first layer and the second layer.

According to an embodiment of the disclosure, the patterns to bend the folding area may be configured by openings provided in the folding area of the support plate, and the at least two wires may be provided along a winding path corresponding to different layers of the patterns included within the folding area of the support plate.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a second housing rotatably connected to the first housing;
a display panel disposed across the first housing and the second housing; and
a digitizer plate disposed below the display panel and comprising wires of a digitizer,
wherein the digitizer plate comprises:
a first plate area disposed in the first housing,
a second plate area disposed in the second housing, and
a pattern area provided between the first plate area and the second plate area and comprising a plurality of openings,
wherein the first plate area and the second plate area of the digitizer plate comprise:
a plurality of layers comprising a first layer and a second layer where the wires of the digitizer are provided, and
at least one additional layer, and
wherein the at least one additional layer in the first plate area and/or the second plate area is provided with an additional wire electrically connected to the wires of the digitizer provided on the first layer and/or the second layer.

2. The electronic device of claim 1,
wherein the patterns provided in the pattern area are configured by the openings provided in a folding area of a support plate, and
wherein, among the wires of the digitizer, wires provided across the first plate area and the second plate area extend from the first plate area to the second plate area along a winding path around the openings of the pattern area.

3. The electronic device of claim 2,
wherein some of the wires provided on the first layer extend to avoid the openings in the pattern area, and
wherein others pass through the at least one additional layer of the pattern area.

4. The electronic device of claim 1, wherein the at least one additional layer is provided between the first layer and the second layer.

5. The electronic device of claim 1, wherein the at least one additional layer comprises:
a first additional layer adjacent to the first layer; and
a second additional layer adjacent to the second layer.

6. The electronic device of claim 5,
wherein the first layer comprises X-channel wires of the digitizer, and
wherein the second layer includes Y-channel wires of the digitizer.

7. The electronic device of claim 6,
wherein the X-channel wires form an electrical loop elongated in a horizontal direction of the electronic device, and
wherein the Y-channel wires form an electrical loop elongated in a vertical direction of the electronic device.

8. The electronic device of claim 7, wherein the additional wire is connected to the wires of at least one of the X-channel or the Y-channel used as a driving channel of the digitizer.

9. The electronic device of claim 8, wherein, in case that the X-channel is used as the driving channel of the digitizer, the additional wire disposed in the at least one additional layer is connected to the wires of the digitizer on the first layer.

10. The electronic device of claim 8, wherein, in case that the Y channel is used as the driving channel of the digitizer, the additional wire disposed in the at least one additional layer is connected to the wires of the digitizer on the second layer.

11. The electronic device of claim 7, wherein, in case that the X-channel and the Y-channel are used as driving channels of the digitizer, an additional wire disposed in the first additional layer is connected to the wires of the digitizer on the first layer, and an additional wire disposed on the second additional layer is connected to the wires of the digitizer on the second layer.

12. The electronic device of claim 1, wherein the additional wire is not disposed in an area of the at least one additional layer where the wires of the digitizer are not disposed.

13. The electronic device of claim 1, wherein the additional wire disposed in the at least one additional layer is connected to the wires of the digitizer on the first layer and/or the second layer via a via hole.

14. The electronic device of claim 1, wherein the additional wire is connected in parallel to the wires of the digitizer.

15. The electronic device of claim 1, further comprising:
a digitizer driving integrated circuit (IC) configured to process a signal from the digitizer,
wherein a connector interconnecting the wires of the digitizer and the digitizer driving IC is disposed in the first housing or the second housing.

16. An electronic device comprising:
a first housing, a second housing, and a hinge housing connected to the first housing and the second housing; and
a flexible display disposed on a foldable housing and comprising:
a display panel and a support plate disposed between the display panel and the foldable housing,
wherein the support plate comprises:
a first area corresponding to the first housing,
a second area corresponding to the second housing, and
a folding area corresponding to the hinge housing, and further comprises patterns to bend the folding area,
wherein the support plate comprises wires to detect an electronic pen, and
wherein, among the wires, at least two wires disposed on different layers of the folding area of the support plate extend in parallel in a first direction via the folding area.

17. The electronic device of claim 16, wherein the at least two wires are connected to each other via at least one via and extend to the first area and/or the second area as a single wire.

18. The electronic device of claim 16, wherein, among the wires, a single wire extending to the first area and the second area of the support plate is connected to at least two wires disposed on different layers of the folding area of the support plate via at least one via.

19. The electronic device of claim 16,
wherein the folding area of the support plate comprises a first layer and a second layer where at least two conductive layers are provided, and
wherein a glass fiber reinforced polymer (GFRP) layer is disposed between the first layer and the second layer.

20. The electronic device of claim 19,
wherein the patterns to bend the folding area are configured by openings provided in the folding area of the support plate, and
wherein the at least two wires are provided along a winding path corresponding to different layers of the patterns comprised within the folding area of the support plate.
